(19) United States
(12) Patent Application Publication
(10) Pub. No.: US 2025/0241807 A1
(43) Pub. Date: Jul. 31, 2025

(54) WEARABLE SYSTEM FOR SMART CONTROL AND WHEELCHAIR DRIVING

(71) Applicant: Georgia Tech Research Corporation, Atlanta, GA (US)

(72) Inventors: Nordine Sebkhi, Atlanta, GA (US); Arpan Bhavsar, Morris Plains, NJ (US); Omer Inan, Marietta, GA (US)

(21) Appl. No.: 19/037,894

(22) Filed: Jan. 27, 2025

Related U.S. Application Data
(60) Provisional application No. 63/625,494, filed on Jan. 26, 2024.

(51) Int. Cl. A61G 5/10; G05B 19/4155

(52) U.S. Cl. CPC A61G 5/10; G05B 19/4155; G05B 2219/35444

(57) ABSTRACT

A wearable universal human-machine-interface (HMI) system and method, based on body-sensed movements via machine learning, that can universally and reconfigurably control multiple assistive devices via a single controller and single set of wearable sensor devices that can be reconfigured to different pre-stored settings for different control functions and devices. The exemplary system and method employ a universal HMI controller that can determine body motion of different body parts as proportion control, discrete control, or combination thereof, as human-machine interface inputs for a power wheelchair and is reconfigurable, via a selection of a set of pre-stored configurations, for different body position inputs. The wearable sensor can be relocated to a different body location. The universal HMI controller is reassignable to a set of pre-defined functions and devices, e.g., changing the power wheelchair, or to interface to other different assistive or HMI devices for mobility, communication, or entertainment.

### RELATED APPLICATION

This U.S. application claims priority to, and the benefit of, U.S. Provisional Patent Application No. 63/625,494, filed Jan. 26, 2024, entitled “WEARABLE BODY MOTION TRACKING SYSTEM,” which is incorporated by reference herein in its entirety.

### BACKGROUND

Tetraplegia (i.e., quadriplegia) is a condition characterized by paralysis of all four limbs (both arms and legs) and the torso, resulting from an injury to the cervical (neck) region of the spinal cord. This condition can be caused by traumatic events such as car accidents or falls, as well as non-traumatic causes like diseases or infections affecting the spinal cord. There are two types of tetraplegia, including (i) complete tetraplegia and (ii) incomplete tetraplegia.

People with tetraplegia may use a variety of equipment to help with mobility, self-care, and communication, including wheelchairs, voice recognition systems, and talking and large-print word processors. Personalized equipment is expensive and often has to be customized for them, and thus, they still need to extensively rely on caregivers for daily activities.

There would be, therefore, a benefit to improving equipment for tetraplegia and people without disabilities.

### SUMMARY

An exemplary wearable universal human-machine-interface (HMI) system and method, based on body-sensed movements via machine learning, are disclosed that can universally and reconfigurably control multiple assistive devices via a single controller and single set of wearable sensor devices that can be reconfigured to different pre-stored settings for different control functions and devices. The exemplary system and method employ a universal HMI controller that can determine body motion of different body parts as proportion control, discrete control, or combination thereof, as human-machine interface inputs for a power wheelchair and is reconfigurable, via a selection of a set of pre-stored configurations, for different body position inputs. The wearable sensor can be relocated to a different body location. The universal HMI controller is reassignable to a set of pre-defined functions and devices, e.g., changing the power wheelchair to interface with other different assistive or HMI devices for mobility, communication, or entertainment.

While various assistive technologies are available for tetraplegia and people with various physical disabilities, they are designed for only one set of functions. The market for tetraplegia and people with various physical disabilities is fragmented as different manufacturers specialize their product offerings to a subset of people. By being able to determine the proportion control, discrete control, or combination thereof, from body parts instrumented with a portable wearable sensor and portable AI device and then being able to map those functionalities to different configurations of a mobility-assistive device, other assistive devices, and other HMI devices, as with the exemplary system and method, the number of devices that the person suffering from tetraplegia or other severe physical disabilities need to interact with is consolidated to one which can be universally used to communicate and control other devices.

As an example, the exemplary system and method can be used as a human-machine interface for digital devices (e.g., tablet, smartphone, TV) using motion data measurements generated by sets of sensors (i.e., tracers) attached to body parts of a person and control values determined by a trained machine learning (ML) model using the motion data measurements. The exemplary system and method are configurable/adaptable for various digital devices and sensor profiles and can be placed anywhere on the person's body. The exemplary system and method are also portable and do not require permanent mounting to a wheelchair as current state-of-the-art control systems.

The sensors of the exemplary system can include inertial sensors, accelerometers, gyroscopes, magnetometers, and inertial measurement units, each having an adhesive to adhere to the skin or clothing. Because the sensors can be attached to the skin or clothing to generate motion data measurements, the person does not need any additional gear (e.g., glasses or headgear) to control the wheelchair or digital devices.

In an aspect, a system is disclosed comprising at least one set of sensors (i.e., tracer) (e.g., gyroscope, accelerometer, magnetometer), including a first set of sensors configured to attach to a body part of a person, wherein each sensor is configured to generate a sensor measurement while the person is making a proportional movement (e.g. tilt, rotation) or discrete gesture; a controller (later shown as Connect device) having a processor; and a memory having instructions stored thereon, wherein execution of the instructions causes the processor to: receive, via the processor, the sensor measurement; determine, via a gesture detection algorithm, a classification value using the sensor measurement, wherein the classification value has a correspondence to a pre-defined gesture among a plurality of gestures; generate, via the processor, a control value using the classification value; and output, via a communication module (e.g., Bluetooth, USB), the control value, wherein the control value is subsequently employed for controls of at least one device.

In some embodiments, the classification value is associated with a proportional gesture defined by a combination of positions, orientations, and angles, wherein the output control value is employed as a proportional control output to the at least one device.

In some embodiments, the classification value is associated with a discrete gesture defined by a combination of positions, orientations, and angles, wherein the output control value is employed as a discrete control output to the at least one device.

In some embodiments, the system described herein further comprises a second set of sensors configured for the discrete gesture of the person, the controller is configured to receive, via the processor, second sensor measurements of the second set of sensors; determine, via the gesture detection algorithm, a second classification value using the second sensor measurements; generate, via the processor, a discrete control value using the second classification value; and output, via the communication module (e.g., Bluetooth, USB), the discrete control value, wherein the discrete control value is subsequently employed, in combination with the proportional control output, for controls of at least one device.

In some embodiments, the classification value is associated with a gesture defined by a combination of positions, orientations, and angles.

In some embodiments, the least one set of sensors includes a non-reusable sticker part to adhere to a skin.

In some embodiments, the second set of sensors is configured to attach to a body part of a person, wherein each sensor is configured to generate the sensor measurement while the person is making a proportional movement or discrete gesture.

In some embodiments, the controller is configured to store a first configuration for the control value for the subsequent control of a first device of the at least one device; store a second configuration for the control value for the subsequent control of a second device of the at least one device; upon receipt of a user command to select the first configuration for the control of the first device, load the controller with the first configuration; and upon receipt of a user command to select the second configuration for the control of the second device, load the controller with the second configuration.

In some embodiments, the controller is configured to store a first configuration for the control value for the subsequent control of the least one device in association with a first sensor placement location on the body; store a second configuration for the control value for the subsequent control of the least one device in association with a second sensor placement location on the body; upon receipt of a user command to select the first configuration, load the controller with the first configuration; and upon receipt of a user command to select the second configuration, load the controller with the second configuration.

In some embodiments, the control value is selectable to a second actionable control output corresponding to a transmission or mobile device (e.g., TV, tablet) or a user-defined device (e.g., computer).

In some embodiments, the controller is operatively coupled to the set of sensors via a wire.

In some embodiments, the controller is operatively coupled to the set of sensors via a wireless tether.

In some embodiments, the controller includes a body strap (e.g., neckband, armband, leg band) to be positioned around a body part for operative coupling to the set of sensors.

In some embodiments, each sensor in the first set of sensors includes a clamping component configured to hold and release the non-reusable sticker part.

In some embodiments, each sensor in the second set of sensors includes a clamping component configured to hold and release the non-reusable sticker part.

In another aspect, a method for a remote control system having at least one set of sensors, including a set of sensors configured to attach to a first body part of a person, wherein each sensor is configured to generate a sensor measurement while the person is making a proportional movement or discrete gesture, the method is disclosed comprising receiving, via a processor, the sensor measurement; determining, via a gesture detection algorithm, a classification value using the sensor measurement, wherein the classification value has a correspondence to a pre-defined gesture among a plurality of gestures; generating, via the processor, a control value using the classification value; and outputting, via a communication module (e.g., Bluetooth, USB), the control value, wherein the control value is subsequently employed for controls of at least one device.

In some embodiments, the method described herein further comprises storing a first configuration for the control value for the subsequent control of a first device of the at least one device; storing a second configuration for the control value for the subsequent control of a second device of the at least one device; upon receipt of a user command to select the first configuration for the control of the first device, loading the controller with the first configuration; and upon receipt of a user command to select the second configuration for the control of the second device, loading the controller with the second configuration.

In some embodiments, the method described herein further comprises positioning the first set of sensors at a first body location; storing a first configuration for the control value for the control of the least one device in association with the first body location; repositioning the first set of sensors at a second body location; storing a second configuration for the control value for the control of the least one device in association with the second body location; upon receipt of a user command to select the first configuration, loading the controller with the first configuration; and upon receipt of a user command to select the second configuration, loading the controller with the second configuration.

In another aspect, a non-transitory computer-readable medium is disclosed having instructions stored thereon, wherein execution of the instructions by a processor causes the processor to receive, via the processor, a sensor measurement; determine, via a gesture detection algorithm, a classification value using the sensor measurement, wherein the classification value has a correspondence to a pre-defined gesture among a plurality of gestures; generate, via the processor, a control value using the classification value; and output, via a communication module (e.g., Bluetooth, USB), the control value, wherein the control value is subsequently employed for controls of at least one device.

### BRIEF DESCRIPTION OF DRAWINGS

FIGS. 1A-1D each shows an example system configured with wearable sensors, a gesture algorithm/software, and a universal HMI controller. FIG. 1A implements the universal HMI controller in two devices: one for aggregating the sensor inputs and performing the gesture classification and a second that provides an interface to an external device. FIG. 1B implements the universal HMI controller also in two devices: the first one only aggregates the sensor inputs, and the second performs the gesture classification and interfacing to the external device. FIG. 1C implements the universal HMI controller in a single device: one for aggregating the sensor inputs that interface to an external device that is configured to perform the gesture classification and its local controls. FIG. 1D implements the universal HMI controller as a driver for a computing system.

FIGS. 2A-2C show example operation flows for the exemplary system of FIGS. 1A-1D.

FIG. 2A shows an example operation flow for the exemplary system. FIG. 2B further shows an example operation flow for configuring the sensors via a controller in the exemplary system. FIG. 2C further shows an example operation flow for configuring the sensors via the controller based on their placement.

FIG. 3A shows an example sensor configuration changing based on sensor placement.

FIG. 3B shows an example interface of the HMI controller.

FIG. 3C shows an example reattachable sensor (i.e., tracers) configured to attach to different body parts of a person and generate sensor measurements.

FIGS. 4A-4D show an example first controller and a second controller. FIGS. 4A and 4B show an example first controller (i.e., Connect) configured to receive sensor measurements from three sets of sensors. If used as a standalone device, as shown in FIG. 4B, the Node receives and processes sensor data from the tracer, and it then sends control values to a target device. FIGS. 4C and 4D show an example second controller (i.e., hub, Display) configured to output, via Bluetooth (a communication module), a control value to external devices. FIG. 4C shows an example controller configured with electronics, connectors, and an embedded tracer. As shown, the controller is configured to receive, via wired connections, the sensor measurements from the reattachable sensors.

FIG. 5 shows an example mechanical design for a reattachable sensor in the exemplary system.

FIGS. 6A-6B show a fabricated system and its various use cases. FIG. 6A shows the fabricated system comprising attachable sensors, a controller, and an interface. FIG. 6B shows the fabricated system used to drive a power wheelchair and control a smart TV via a mobile app on a smartphone.

FIGS. 7A-7B show an embodiment of the fabricated system used in the training sessions (e.g., #1-#3) for the experiment. FIG. 7A shows the embodiment used in the experiment comprising sensors (i.e., tracers), a controller, and an interface. FIG. 7B shows the Session #1 training for the experiment. FIG. 7C shows the Session #2 training for the experiment. FIG. 7D shows the Session #3 training for the experiment.

FIGS. 8A-8B show the three embodiments #1, #2, #3 of the exemplary system and an manufacturing process for the embodiment #2. FIG. 8A shows the embodiments #1, #2, and #3 of the exemplary system. FIG. 8B shows the fabrication process of the embodiment #2.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example System

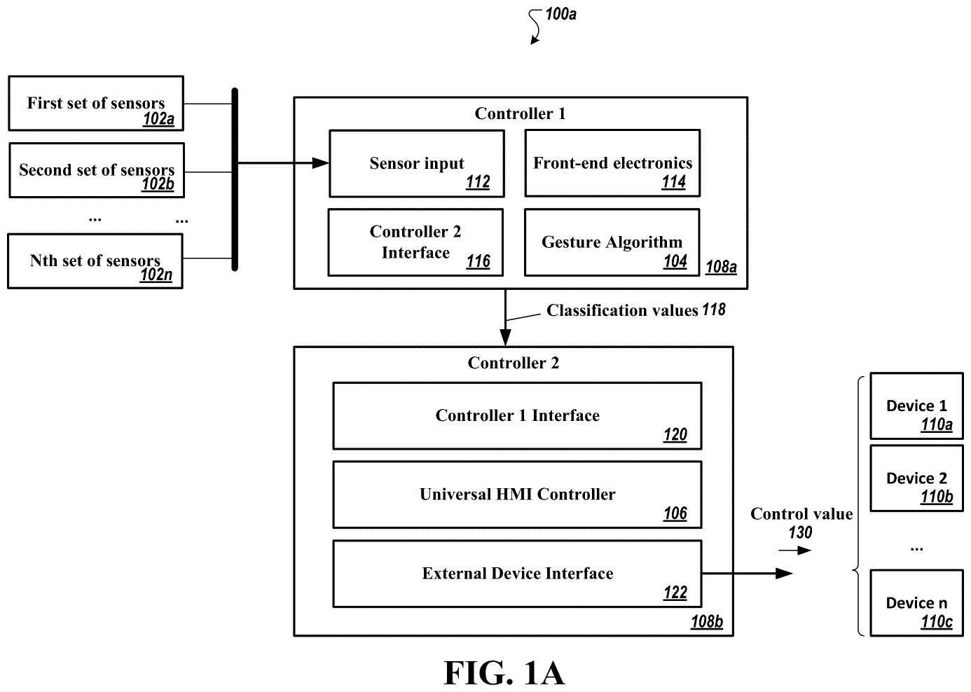

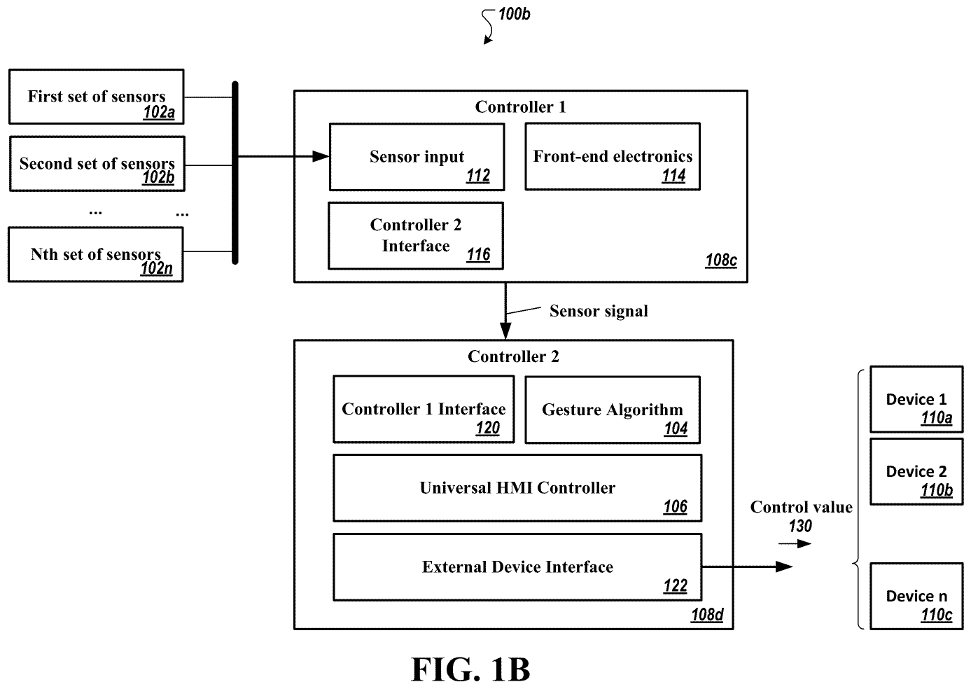

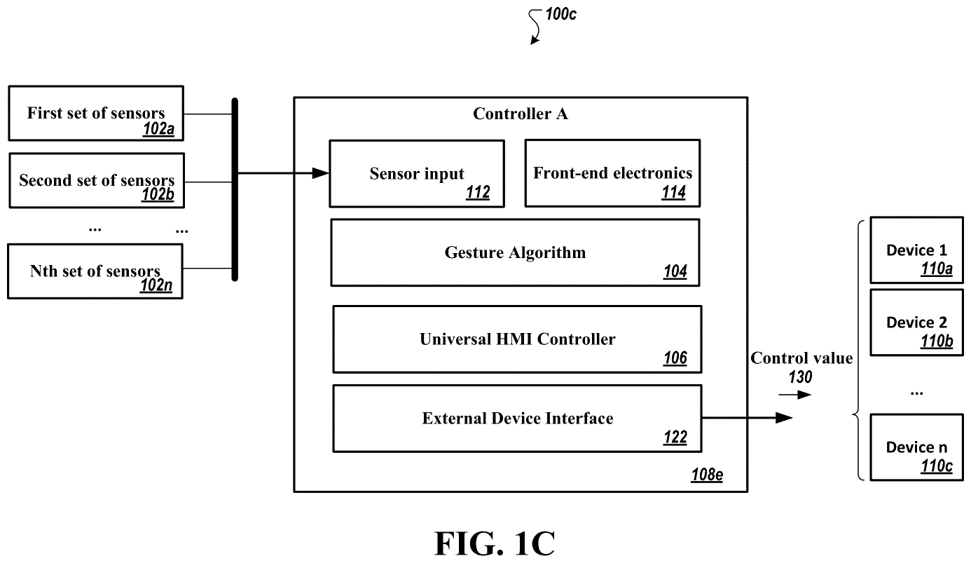

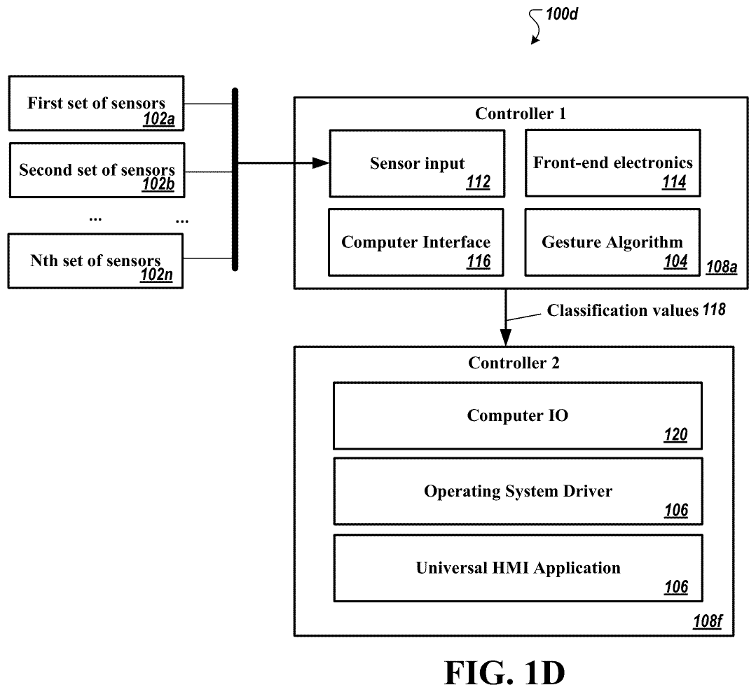

FIGS. 1A-1D each shows an example system 100 (shown as 100a, 100b, 100c, 100d) configured with wearable sensors 102, a gesture algorithm/software 104, and a universal HMI controller 106 to interface to a device 110. FIG. 1A implements the universal HMI controller 100a in two devices (108a, 108b): one (108a) for aggregating the sensor inputs and performing the gesture classification and a second (108b) that provides an interface to an external device. In some embodiments, the second controller is the external device controller. FIG. 1B implements the universal HMI controller 100b also in two devices (108c, 108d): the first one (108c) only aggregates the sensor inputs, and the second (108d) performs the gesture classification and interfacing to the external device. FIG. 1C implements the universal HMI controller 100c in a single device 108e: one for aggregating the sensor inputs that interface to an external device that is configured to perform the gesture classification and its local controls. FIG. 1D implements the universal HMI controller 100d as a driver 108f for a computing system. The same or functionally equivalent wearable sensors 102, gesture algorithm/software 104, and universal HMI controller 106 are implemented in each of the systems of FIGS. 1A-1D in different combinations.

### Sensor 102.

In FIGS. 1A-1D, sensors 102 includes a plurality of wearable sensor assemblies (shown as 102a, 102b, . . . 102n) that may each contain a set of one or more sensor elements, e.g., include inertial sensors, accelerometers, gyroscopes, magnetometers, inertial measurement units, etc. Each sensor 102 (e.g., 102a, 102b, . . . , 102n) can be placed at a body location to measure a voltage or current corresponding to an acceleration, a movement, an orientation change, a sensed magnetic field, an angle, or a combination thereof (e.g., in an IMU having multiple axis acceleration and gyroscopes) corresponding to a body movement at a definable body location. The movement can be determined via a gesture algorithm configured to determine a control value for the movement to which proportional control output or discrete control output can be mapped. In some embodiments, the gesture algorithm is configured to output a proportional control output or a discrete control output directly. That is, in the first example, the output is a value corresponding to a body movement/motion/orientation to which a proportional control transfer function or a discrete control transfer function can be mapped. In the second example, the gesture algorithm output itself is a proportional control value or a discrete control value. The sensors 102 may be coupled to a sacrificial non-reusable adhesives sticker that allows the same sensor to be reused for different usages. In some embodiments, the sacrificial non-reusable adhesives may be coupled to an intermediate clamping component configured to release the sensor 102.

Proportion control has a range of outputs, e.g., 0 to 1 as a double or float data format and 0 to 255 for an integer data format (8-bit). The data output for the proportional values can be 8-bit, 9-bit, 10-bit, 11-bit, 12-bit, 13-bit, 14-bit, 15-bit, 16-bit, 17-bit, 18-bit, 19-bit, 20-bit, 21-bit, 22-bit, 23 bit, 24 bit, or more. The output can be binary or hexadecimal. Proportional control has a similar output as a joystick that can provide a range of input in 1-axis, 2-axis, or 3-axis. It is contemplated that the gesture algorithm can be configured to output proportional control values for any of these bits, data formats, or axes. Multiple gesture algorithms may be implemented for an output type.

Discrete control has a discrete value of 0 and 1 or −1 and 1. It can also be expressed an “on”/“off” or “enabled”/“disabled”. The data output for the discrete values can be 1-bit, 2-bit, or more. The output can be binary or hexadecimal. Discrete control has a similar output to a toggle switch or a button. It may be latched (i.e., hold value until a different sensing is measured) or momentary (hold value for a given sensed position).

### Gesture Algorithm 104.

The gesture algorithm or gesture algorithm module is configured to determine a control value for the movement to which proportional control output or discrete control output can be mapped or to output such proportional control output or discrete control output directly. The input of the gesture algorithm module is a sensor input from one of the wearable sensors 102 that may include one or more sensing elements of the same or different types positioned at a body location on the user. The sensing input may be a measure of acceleration, movement, orientation change, sensed magnetic field, angle, or a combination thereof (e.g., IMU). The body part can be on the head, face, neck, finger, hand, wrist, forearm, elbow, shoulder, knee, foot, ankle, and toes. In some configurations, the body part/location is user-defined. The gesture algorithm, e.g., for a 9-axis inertial sensor comprising a 3-axis gyroscope, 3-axis accelerometer, and 3-axis magnetometer, may include a traditional sensor fusion algorithm based on a Kalman filter. Additional details about the algorithm can be found in Sebkhi et al., Evaluation of a Head-Tongue Controller for Power Wheelchair Driving By People With Quadriplegia. Trans Biomed Eng, 69(4), 1302-1309, which is incorporated by reference herein.

The output of this algorithm is an estimate of the orientation of a body part which is mappable into a command, e.g., roll angle controls the steering (i.e., turning left-right), and the pitch angle controls the speed going forward or backward. The angle thresholds are adaptable to the user's range of motion during calibration and identify the maximum pitch/roll angles that the user can reach and the angles at which lower values do not issue any command to prevent natural body movements from issuing unintended driving commands.

### Machine Learning.

The gesture algorithm can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tan h, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

### Other Supervised Learning Models.

A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Universal HMI Interface 106.

The universal HMI interface 106 is configured to provide selectable and reconfigurable operation via a selection of a set of pre-stored configurations for different body position inputs, sensor input, selection of a control type as proportional or discrete, and selection of a controllable output function for that control and sensor. It is contemplated that the different control types and body positions can be calibrated and pre-stored by a technician, to which the user can then map such control types and body positions to a controllable device and function. The universal HMI controller 106, in essence, enables the exemplary system 100 as a universal HMI or remote control for any connectable external device 110 (shown as 110a, 110b, 110c) for mobility, communication, or entertainment.

First Two-Device Configuration. In the example shown in FIGS. 1A, the first controller (shown as “Controller 1”) 108a) is configured to provide interface hardware for sensors 102 and perform gesture classification 104 for the HMI controller; the second controller (shown as “Controller 2” 108b) interfaces with the first controller 108a and receive the universal HMI controller 106.

The first controller 108a includes sensor input 112, front-end electronics 114, a controller interface 116 (shown as “Controller 2 Interface” 116), and the gesture algorithm module 104. The output of the first controller is classification value 118. The second controller 108b includes a controller interface 120 (shown as “Controller 1 interface”), the universal HMI controller 106, and an external device interface 122.

In the first controller 108a, the sensor input 112 includes a physical terminal (e.g., male/female ports) to connect to the set of sensors 102. The terminal may include strain relief. The front-end electronics 114 couples to the sensor input and include buffer, isolators, pre-amplifiers, and analog-to-digital conversion circuit to receive the signals from the sensors 102 and convert them to a digital signal to be used by the gesture algorithm module 104. The gesture algorithm module 104 generates a set of gesture values (or proportional/discrete values) for a received signal and outputs the gesture values to the controller interface 116. The controller interface 116 provides short-distance communication and network MAC and PHY operations with the second controller 108b. In some embodiments, the controller interface is based on serial communication, e.g., Bluetooth, USB, etc.

In the second controller 108b, the controller interface 120 provides a short-distance communication connection with the first controller 108a. In some embodiments, the controller interface 120 includes network MAC and PHY for wire or wireless networks. The universal HMI controller 106 provides the selectable and reconfigurable operation via a selection of a set of pre-stored configurations for different body position inputs, of sensor input, selection of a control type as proportional or discrete, and selection of a controllable output function for that control and sensor. The external device interface 122 provides short-distance communication operations to an external device 110. The external device interface 122 can connect to one device (110) at any given time, but the connection can be reconfigured to switch to different devices. In some embodiments, the external device interface 122 is an optical, infrared remote control transmitter. The transmitter includes IR protocol to operate with the external device 110′ (e.g., to connect to a mobile device (e.g., TV, tablet) or a user-defined device (e.g., computer)). In some embodiments, the second controller 108b may be configured with a DB9 connection to connect to the controller of a power wheelchair.

In some embodiments, the second controller 108b is a local device controller for the device 110. In such instances, the wheelchair controller, for example, implements the functionality of the universal HMI controller 106.

### Second Two-Device Configuration.

In the example shown in FIGS. 1B, the first controller (“Controller 1” 108c) is configured to provide only interface hardware for sensors 102. The second controller (“Controller 2” 108d) includes the universal HMI controller 106 and is additionally configured to perform gesture classification 104. In FIG. 1B, like components to those of FIG. 1A are labeled with the same reference numbers. The first controller 108c also includes sensor input 112, front-end electronics 114, and controller interface 116.

In the first controller 108c, the sensor input 112 includes a physical terminal and strain relief to connect to the set of sensors 102. The front-end electronics 114 couples to the sensor input and include buffer, isolators, pre-amplifiers, and analog-to-digital conversion circuit to receive the signals from the sensors 102 and convert them to a digital signal. The controller interface 116 connects to the front-end electronics to provide a short-distance communication connection with the second controller 108b.

In the second controller 108d, the controller interface 120 connects the second controller 108d with the first controller 108c. The second controller 108d additionally includes the gesture algorithm module 104 to generate a set of gesture values (or proportional/discrete values) for a received signal from the first controller 108c. The universal HMI controller 106 connects directly to the gesture algorithm module 104 to provide the selectable and reconfigurable operation via a selection of a set of pre-stored configurations for different body position inputs, of sensor input, selection of a control type as proportional or discrete, and selection of a controllable output function for that control and sensor. The external device interface 122 provides short-distance communication operations to an external device 110.

### One-Device Configuration.

In the example shown in FIGS. 1C, a single controller (shown as “Controller D” 108e) is configured to singularly provide interface hardware for sensors 102, provide the gesture algorithm operation, the universal HMI controller, and the external device interface. In FIG. 1C, like components to those of FIGS. 1A and 1B are labeled with the same reference numbers. The controller 108e also includes sensor input 112, front-end electronics 114, and device interface 122.

### Operating System Configuration.

In the example shown in FIGS. 1D, the first controller (shown as “Controller 1” 108a) is configured to provide interface hardware for sensors 102, perform gesture classification 104 for the HMI controller, and interface to the operating system of a computing device.

In this example, the computer interface 116 is configured to interface with a computer I/O. Examples can include universal serial bus (USB), peripheral component interface (PCI), and the like. The universal HMI controller may be implemented as an application that interacts with the gesture input through operating system drivers.

### Example Method of Operation

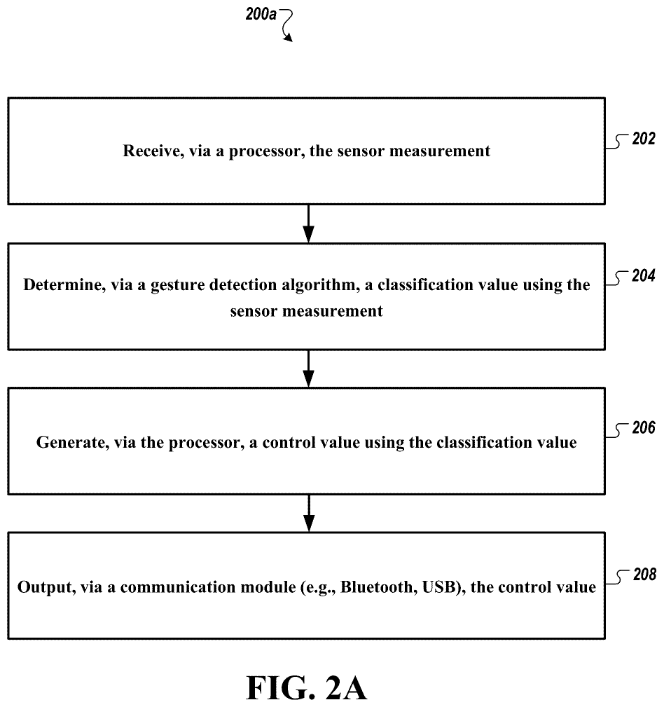

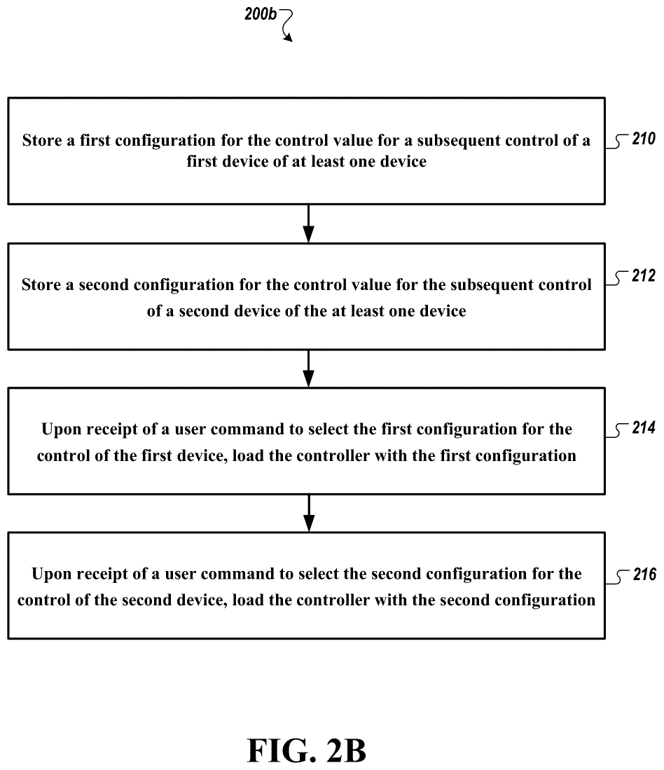

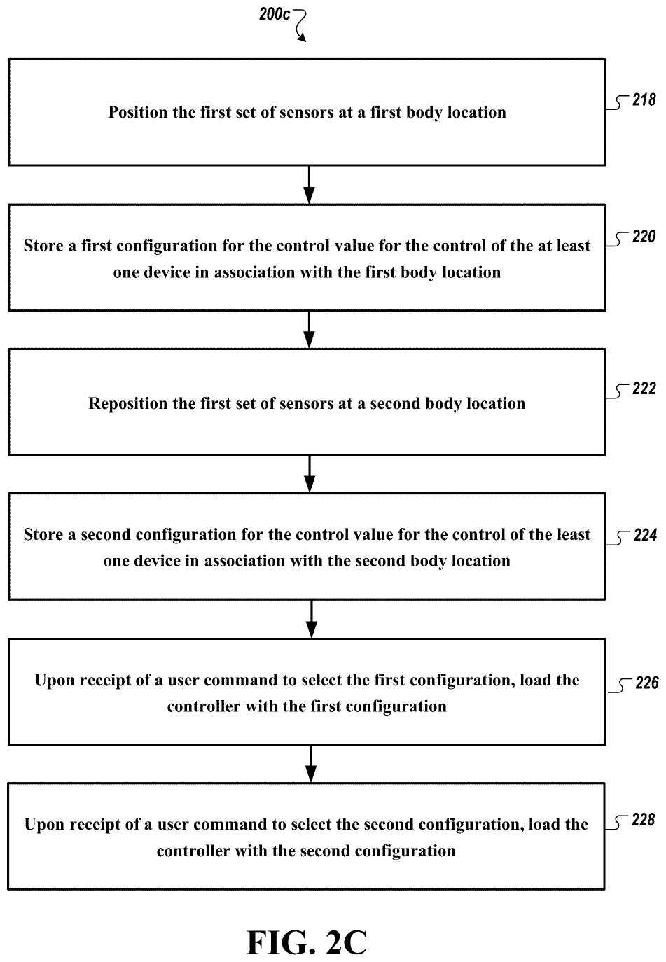

FIGS. 2A-2C show example operation flows 200a-200c for the exemplary system.

### Operation 1.

FIG. 2A shows an example operation flow 200a for the exemplary system, which can comprise 4 steps. At step 202, the exemplary system receives, via a processor, a sensor measurement. At step 204, the exemplary system can determine, via a gesture detection algorithm, a classification value using the sensor measurement. At step 206, the exemplary system can generate, via the processor, a control value using the classification value. At step 208, the exemplary system can output, via a communication module (e.g., Bluetooth, USB), the control value.

### Operation 2.

FIG. 2B further shows an example operation flow 200b for configuring the sensors via a controller in the exemplary system, which can comprise 4 steps. At step 210, the exemplary system can store a first configuration for the control value for a subsequent control of a first device of at least one device. At step 212, the exemplary system can store a second configuration for the control value for the subsequent control of a second device of the at least one device. At step 214, upon receipt of a user command to select the first configuration for the control of the first device, the exemplary system can load the controller with the first configuration. At step 216, upon receipt of a user command to select the second configuration for the control of the second device, the exemplary system can load the controller with the second configuration.

### Operation 3.

FIG. 2C further shows an example operation flow 200c for configuring the sensors via the controller based on their placement, which can comprise 6 steps. At step 218, the user/person can position the first set of sensors at a first body location. At step 220, the exemplary system can store a first configuration for the control value for the control of the at least one device in association with the first body location. At step 222, the person can reposition the first set of sensors at a second body location. At step 224, the exemplary system can store a second configuration for the control value for the control of the least one device in association with the second body location. At step 226, upon receipt of a user command to select the first configuration, the exemplary system can load the controller with the first configuration. At step 228, upon receipt of a user command to select the second configuration, the exemplary system can load the controller with the second configuration.

### Example Reconfigurability of Sensor Placements and Configurations

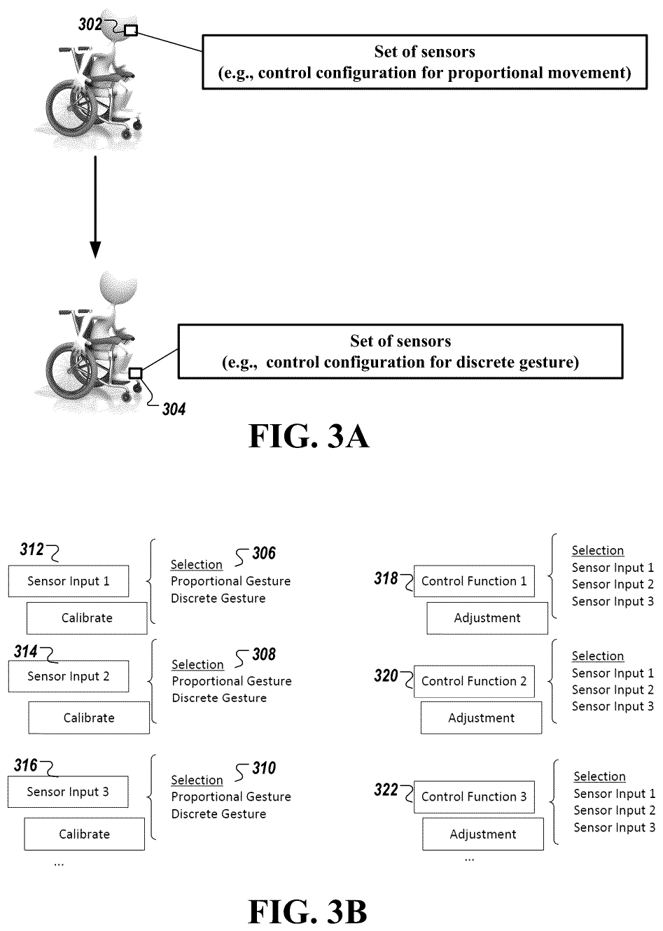

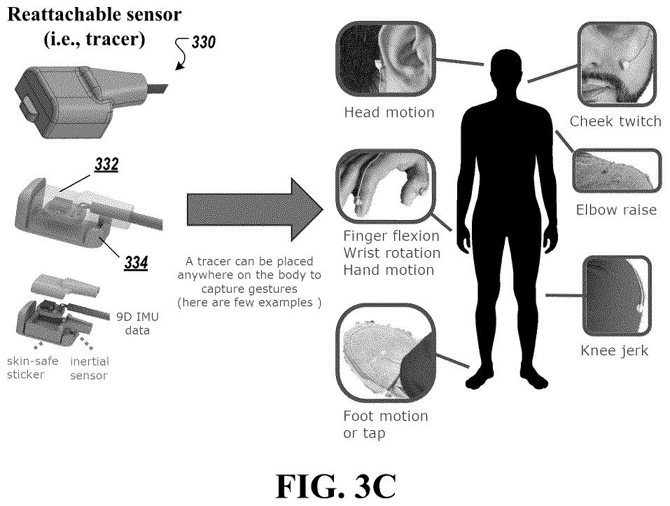

FIG. 3A shows an example sensor configuration changing based on sensor placement. As shown, the set of sensors is positioned at a first body location 302 (e.g., face). The exemplary system can store a first configuration for the control value for the control of at least one device in association with the first body location 302. The set of sensors is then repositioned at a second body location 304 (e.g., foot). The exemplary system can then store a second configuration for the control value for the control of the least one device in association with the second body location 304. Upon receipt of a user command to select the first configuration, the exemplary system can load its controller with the first configuration. Upon receipt of a user command to select the second configuration, the exemplary system can load its controller with the second configuration.

### Example HMI Graphical User Interface

FIG. 3B shows an example graphical interface of the HMI controller. As shown, the HMI controller can provide selections of configurations (e.g., 306-310) for each set of sensor inputs 312-316 (shown as 112 in FIGS. 1A-1D). The HMI controller can also provide selections of control functions 318-322 for available sets of sensor inputs.

Specifically, each sensor input 312, 314, 316, and so forth, is presented in the GUI to be selectable by a user (e.g., technician, doctor, therapist, nurse, caregiver, medical staff). The technician or doctor can program and calibrate a range of motion of a body position with a sensor placed thereon. The range of motion and associated measured signal of the sensors are stored as pre-sets for a configuration. The pre-stored configuration can then be later selected by the user, who can designate a preset input (e.g., 306, 308, 310) as a proportional gesture or a discrete gesture. The preset input can be mapped or associated with a control function (e.g., 318, 320, 322) for the external controller. To this end, the HMI controller can universally connect the sensor and gesture algorithm system, i.e., reconfigured to different pre-stored settings for different control functions and devices.

### Reattachable Tracers.

FIG. 3C shows an example reattachable sensor 102 (i.e., tracers 330). The sensor 330 is embedded within a sensor housing 332 that is configured to reattachably connect to a clamp/holder 334. The clamp/holder may be affixed with an adhesive, or the clamp/holder may be disposable (e.g., for daily use) to be attached to the skin of the user or the user's clothing for the day. In this manner, the sensor/tracer and associated electronics can be reused with a new clamp/holder or adhesives being replaced for optimal daily continuous usage.

As shown in FIG. 3C, the sensors can be ubiquitously placed anywhere on the user's body, e.g., behind the ear, on the face (e.g., cheeks), on the finger, on the shoulder or clothes thereat, on the foot or shoes, or on the knee or associated position on the pants.

In this example, the sensor is a 9-dimensional inertia measurement unit (9D IMU).

### Example Hardware Implementation

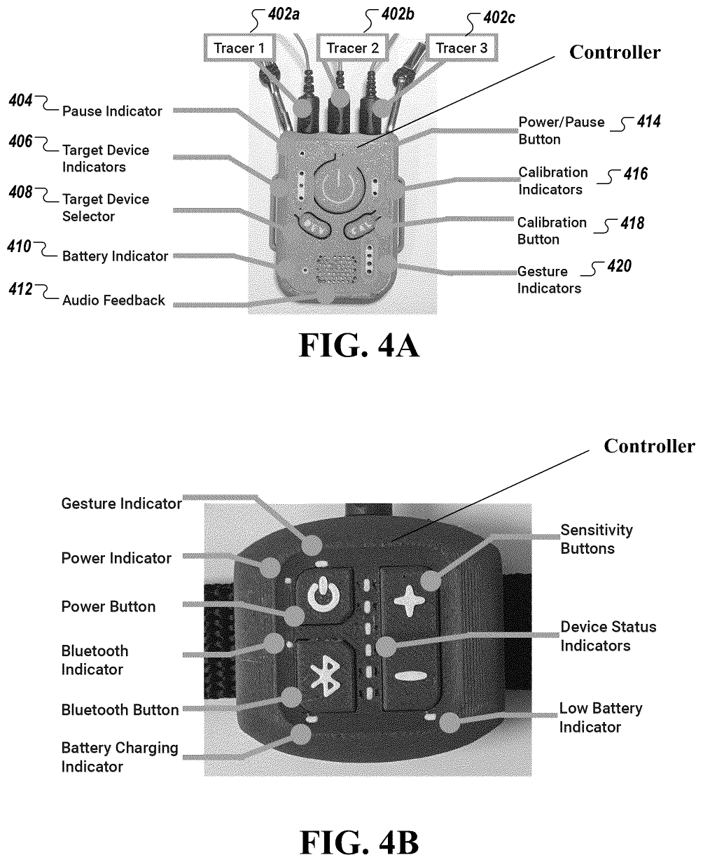

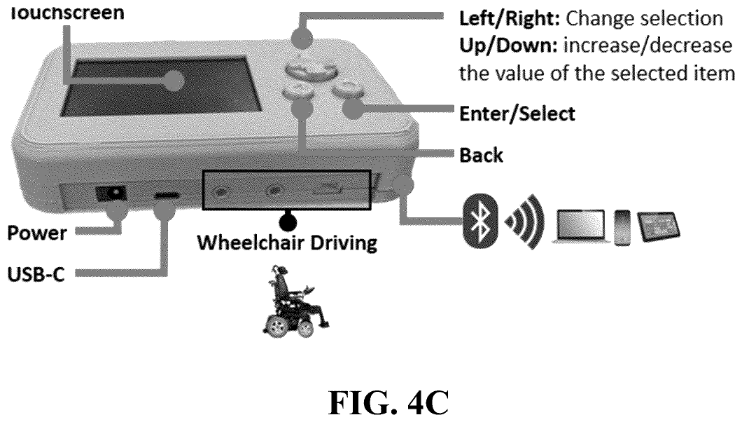

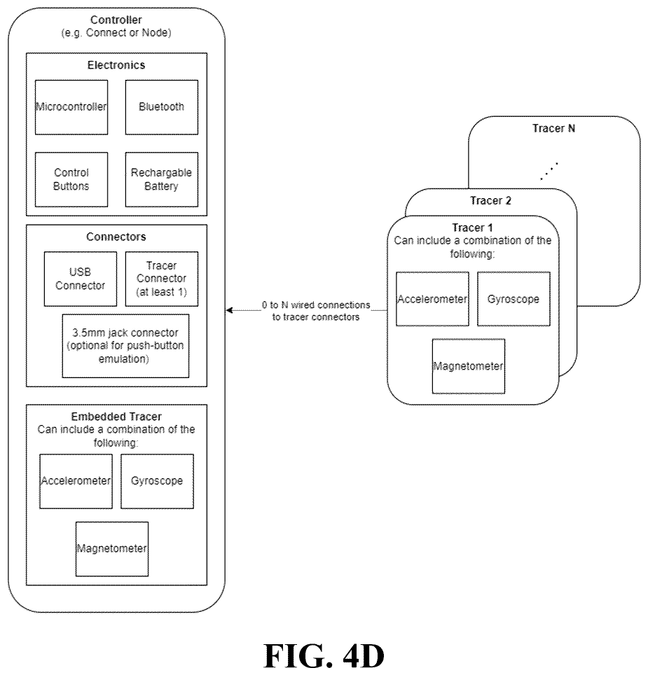

FIGS. 4A-4C show example hardware implementation for the controllers, e.g., 108a, 108b, 108c, 108d, 108e. FIGS. 4A and 4B each show an example first controller (e.g., 108a, 108e) configured to provide interface hardware for sensors 102 and perform gesture classification 104 for the universal HMI controller. FIGS. 4C and 4D show another example of a second controller (e.g., 108d, 108e) configured to perform gesture classification 104 for the universal HMI controller.

In the example shown in FIG. 4A, the controller includes inputs for three sets of tracers 102 (shown as 402a, 402b, 402c). The user interface, via LEDs, includes indications for pause indicator 404, target device status indicators 406, target device selectors 408, battery indicator 410, audio feedback output 412, power/pause button 414, calibration indicator 416, calibration button 418, and gesture indicator 420.

Pause indicator 404 indicates the gesture output is disabled/paused. Target device indicator 406 indicates a selected target device, e.g., 1, 2, 3. Target detect selector 408 provides input to select/toggle between a selectable target device, e.g., 1, 2, 3. Battery indicator 410 indicates available battery power or low battery power. Audio feedback 412 provides a sound, beep, series of beeps, or voice that conveys information about an action that has been detected by the device (feedback to the user that a gesture has been detected), an instruction to the user (such as a calibration step), or an alert such as an emergency stop or other failure. Power/Pause Button 414 provides input to select between power on/off and pausing. The button may be held for a pre-defined period of time to turn “on” (e.g., 3 seconds), a period of time to turn “off” (e.g., 3 seconds), and a quick click (e.g., less than 1 second) can cycle between pause on/off. Calibration indicator 416 may provide an output for a good calibration sequence and a bad calibration sequence upon a calibration sequence being executed. Calibration may be initiated by pressing the calibration button 418. Gesture indicator 420 may output a detected gesture. The LEDs may flash or stay lit depending on whether the device detects valid movements from a tracer. The LED may blink momentarily to indicate a gesture was detected or may stay lit while the user is moving a tracer proportionally. FIG. 4B shows another example controller (e.g., 108a, 108b, 108c, 108d, 108e) configured to output, via Bluetooth, a gesture control value to external devices. In FIG. 4B, the connection to the sensors 102 and to the external controller device are over wireless communication.

FIG. 4D shows example components of the controller of FIG. 4C. The controller includes electronics comprising microcontroller, control IO, rechargeable battery and power circuits, and communication circuits (shown as “Bluetooth). The controller also includes connectors comprising USB connectors, tracer connectors, and a 3.5 mm jack connector. The controller may include embedded sensors comprising accelerometers, gyroscopes, and magnetometers. The controller may communicate with additional tracers (e.g., 1, 2, 3, . . . , N) each configured with accelerometers, gyroscopes, and magnetometers.

### Example Mechanical Design of Reattachable Sensor

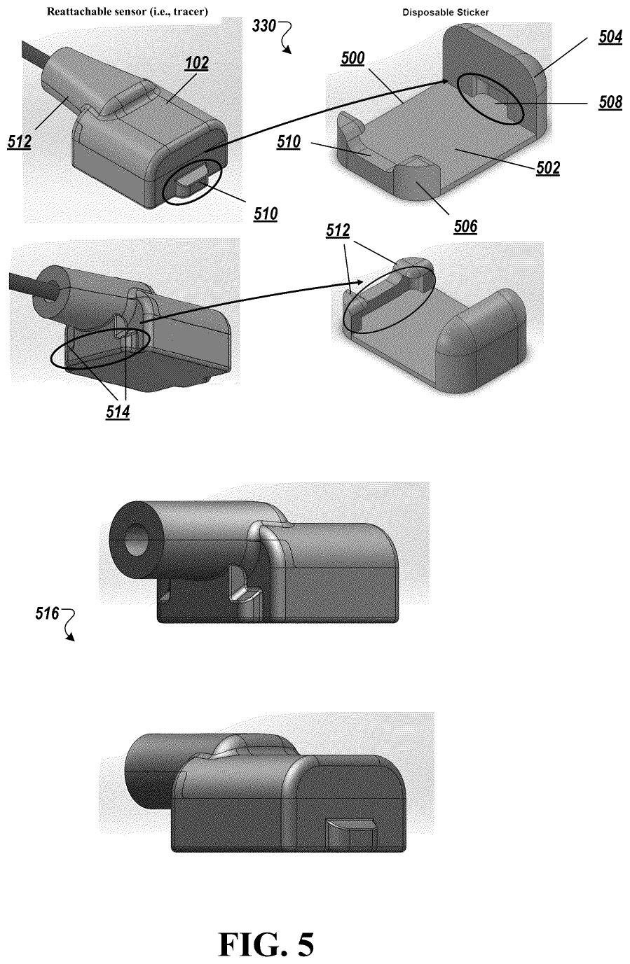

FIG. 5 shows an example mechanical design for a reattachable sensor 330 in the exemplary system. As shown, each sensor 330 includes a clamping 500 component and the tracer sensor 102.

The clamping component 500 has a base 502 and a front and rear wall 504, 506 for retaining the tracer. The front wall 504 includes recess region 508 to receive a keying protrusion 510 extending from the tracer 102. The rear wall 506 includes a groove region 510 to receive the cable/neck portion of the tracer 102. The groove region 510 includes two protrusions 512 to fit with a corresponding keying/locking region 514 on the neck portion of the tracer 102. FIG. 5 shows a second view 516 of the tracer 102.

### Experimental Results and Additional Examples

A study was conducted to develop and evaluate the exemplary system and method comprising (i) at least two or more sets of sensors (i.e., tracers) (e.g., gyroscope, accelerometer, magnetometer) and (ii) a controller for remote controls of a wheelchair or digital devices (e.g., smartphone, TV, etc.). The exemplary system and method may replace the need for multiple controllers with one integrated system that gives users control over their power wheelchair and digital devices (e.g., TV, tablet) and switch control between devices without caregiver intervention or hardware adjustment.

### Fabricated System.

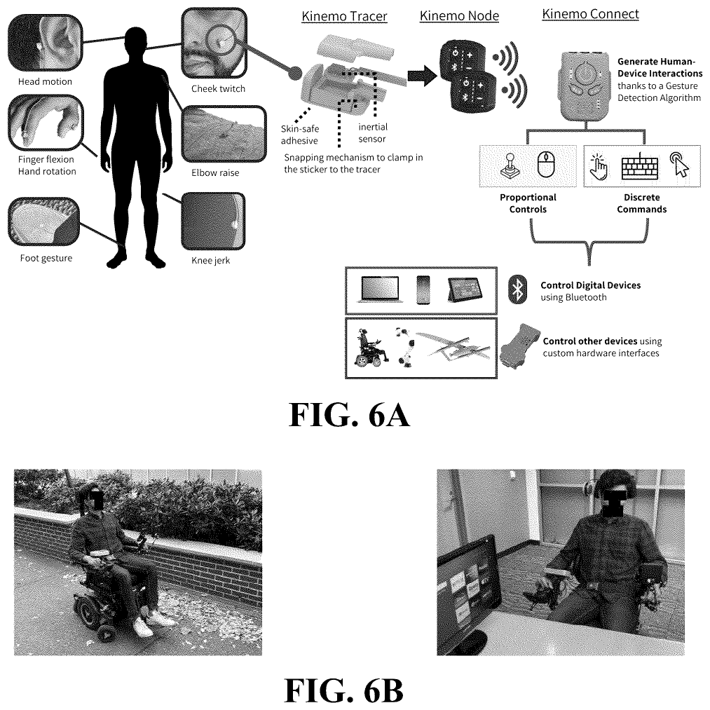

FIG. 6A shows a fabricated system comprising attachable sensors, a controller, and an interface. As shown, the attachable sensors were configured to attach to any body part with sufficient motion, such as the head, face, or fingers and measured the motion data. The controller then directed control outputs generated from the motion data to a wheelchair and digital devices via an interface.

To capture body motion, the controller translated the movement of small custom tracers into proportional control if placed on a body part with at least one axis of motion (e.g., head, hand) and into discrete control when placed on a body part where a gesture can be detected (e.g., face, finger, shoulder, knee). Each tracer was adhered to the skin using a custom, non-reusable sticker comprised of a release liner and a skin-safe adhesive. Motion data of the body part was captured by a 9D inertial sensor (i.e., accelerometer, gyroscope, and magnetometer) embedded in the tracer and transmitted to the controller (i.e., a neck-worn wearable accessory called the Connect). The interface (i.e., a portable processing unit called the Display) processed this data and generated output controls that were transmitted to a target device.

FIG. 6B shows the fabricated system used to drive a power wheelchair and control a smart TV via a mobile app on a smartphone. In subpanel (a), by using the head (or hand or knee) for proportional control, a user drove their wheelchair proportionally, resulting in a responsive and precise driving experience. They independently changed their seating and accessed other wheelchair functions (e.g., horn, lights, drive profiles) by using a body gesture as a user switch and proportional control for navigating the menus. To control a digital device, the same proportional control was used to move a pointer, while body gestures allowed the user to click, hold, scroll, or drag on the screen. Users can seamlessly switch between controlled devices via a special combination of body gestures. The fabricated system supported all leading wheelchair brands by plugging into the industry standard 9-pin connector for specialty input controls and into a user switch port and any modern digital device via Bluetooth.

### Experiment Preparation.

Seven able-bodied participants completed this experiment, comprised of five male and two female subjects aged 21-38. The experiment was split into three sessions: Session #1 focused on training the subjects on controlling connected devices; Session #2 trained them on driving a PWC, and Session #3 combined both controls (power wheelchair (PWC) driving and connected devices) to perform tasks of daily living inside a house. Each session lasted between 2 and 3 hours. Additionally, the subjects were asked to provide their feedback after completing each task, along with responding to survey questions to record their experience with key aspects of the system.

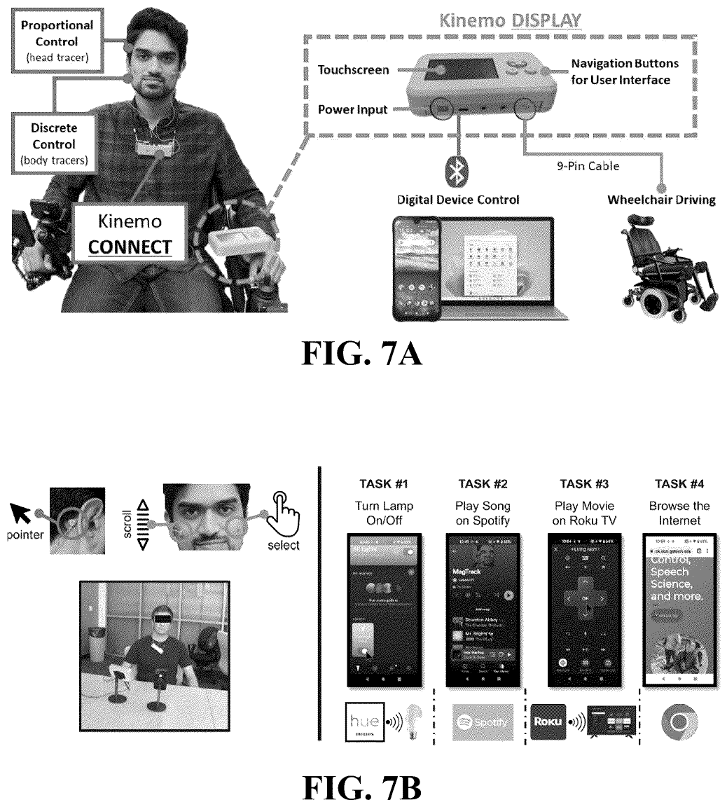

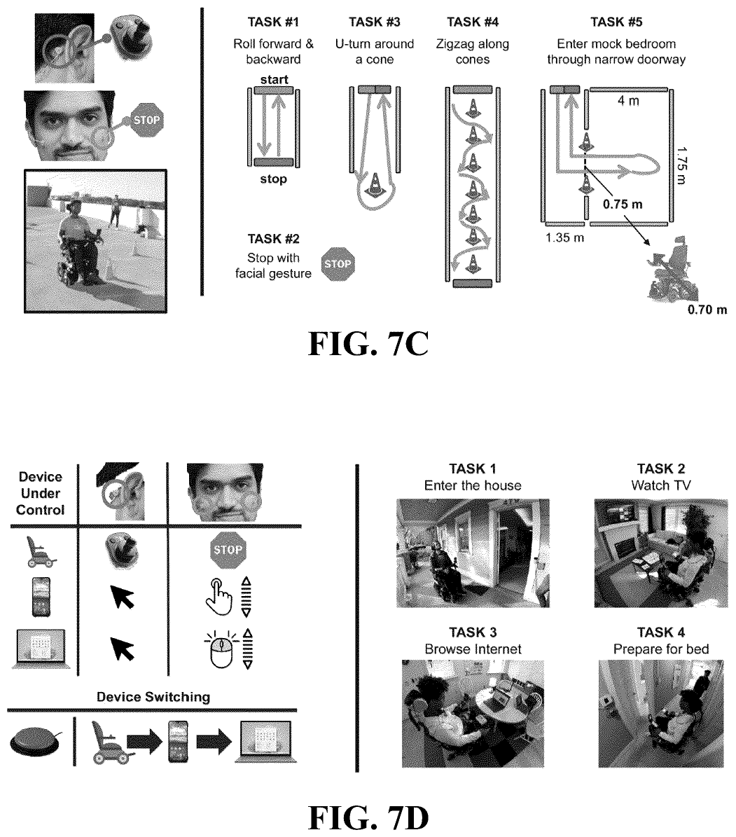

FIG. 7A shows the embodiment used in the experiment comprising sensors (i.e., tracers), a controller, and an interface. As shown, the controller (shown as Connect) was a custom-designed electronic neckwear connected to multiple wired tracers that capture the motion of body parts. The tracers' data were transmitted from the controller to the interface (shown as Display) using a wired connection when the user was in the wheelchair and needed reliable communication when driving the wheelchair or wirelessly when the user was away from the wheelchair. The interface processed the tracer's data and translated the user's intent into control inputs for a target device.

### Session #1—Training for Smart Control.

FIG. 7B shows the Session #1 training for the experiment. The fabricated system was paired via Bluetooth to a smartphone (e.g., Pixel 4a, Android) and controlled as follows: head motion moved the pointer, a twitch of the left cheek emulated a finger tap (i.e., Select), and holding the right cheek for few seconds toggled the Scroll mode which translated head movements into scrolling. This session was composed of four tasks: (#1) Turn on/off a smart lamp, (#2) Play a song on Spotify, (#3) Play a video on a smart TV (e.g., Roku), and (#4) Browse the internet (e.g., scroll through pages of a website to play a specified video). Each task was timed and repeated three times.

### Session #2—Training for PWC Driving.

FIG. 7C shows the Session #2 training for the experiment. Subjects were trained to drive a PWC (e.g., Permobil M3) with the fabricated system on indoor courses delimited by cones. The speed profile was set to Indoor Slow (e.g., 1.4 mph max speed forward). Proportional driving was performed via head motion with tilting (i.e., ear to shoulder) for turning and nodding up/down for rolling forward/backward. The twitch of the right cheek was used to stop the PWC. The tasks were as follows: (#1) Roll forward (13 m) and backward to the start line, (#2) Stop the PWC with a facial gesture, (#3) U-turn around a cone (11 m), (#4) Turn in a zigzag along 7 cones whose intervals were decreasing from 2 m to 1 m, (#5) Enter and exit a mock bedroom through a narrow doorway (75 cm) delineated by cones. Each task was completed first with the joystick of the PWC (except task #2), then repeated three times with the fabricated system. The driving was done in unlatched mode, except for task #2.

### Session #3—Smart Control and Indoor Driving in a Home Setting.

FIG. 7D shows the Session #3 training for the experiment. Both controls were combined to perform tasks that an end-user may do when coming back home: (#1) Enter the house through the main entrance, (#2) Play a movie on the smart TV, (#3) Turn on a smart lamp and browse the internet on a computer (e.g., scroll through pages of a website to play a specified video), and (#4) Prepare for bed by driving through a hallway, use a smartphone app to open the automated bedroom door, and park parallel to the bed. First, the subjects completed this sequence of tasks in one trial with the joystick to drive the PWC and their hand/fingers to control the phone and computer. Then, they were set up with the fabricated system and completed the sequence three times. Two facial sensors (i.e., tracers) were placed on the cheeks and issued the same discrete commands as described in the previous sessions. For computer control, the twitch of the left/right cheek issued a left/right mouse click, and holding the right cheek for a few seconds toggled the scroll mode. Since there were three devices to be controlled (PWC, smartphone, and computer), the study implemented a method to allow the subjects to independently switch between the devices by using a head clicker: 1 click for PWC driving, 2 clicks for phone control, and 3 clicks for computer control.

### Experimental Results.

The completion time of each trial was recorded, along with a difficulty score ranging from 1 (very difficult) to 5 (very easy). For tasks with PWC driving, the number of collisions with an object was also recorded, which was a cone in Session #2, but in Session #3, the objects were a piece of furniture, a door, the side of a doorway, or even the wall.

### Session #1 Result.

Table 1 shows the completion time (in seconds) for the human subjects (e.g., S1-S7) in Session #1.

TABLE 1

| Task | S1 | S2 | S3 | S4 | S5 | S6 | S7 |
|---|---|---|---|---|---|---|---|
| #1 | 25 | 16 | 24 | 21 | 27 | 15 | 18 |
| #2 | 53 | 34 | 41 | 56 | 61 | 34 | 30 |
| #3 | 55 | 50 | 63 | 70 | 77 | 37 | 39 |
| #4 | 57 | 51 | 71 | 72 | 81 | 42 | 40 |

As shown in Table 1, the fastest subject (S7) was, on average, twice as fast as the slowest subject (S5). Subjects S6-S7 were not only the fastest but also the only participants with prior experience with the fabricated system, and thus, they had more practice time than others. Excluding subjects S6-S7, the next fastest subject (S2) completed the tasks on average 40% faster than the slowest. Subject #2 had a spinal cord injury two years prior that left him with incomplete tetraplegia for a short amount of time (four months). Before this subject fully recovered, he was using a hand stylus to control his mobile devices, and therefore, it was not clear whether this prior history with tetraplegia had any influence on his performance since he did not use a head tracker for alternative control, or whether being the youngest participant (21 years old) had any impact.

Although not shown in Table 1, the third trial was completed faster than the first in three tasks and across subjects. However, this increased performance in completion time became less significant as the subjects progressed through the tasks. These results may indicate that the subjects were becoming more proficient with the fabricated system's control as they practiced throughout the session, which validated the previous observation that subjects S6-S7 were the fastest because they had prior practice time than the others. Although comparing the fabricated system's performance to other alternative controls (Acs) may be useful to validate this assumption, the purpose of this session was to train the subject on the fabricated system for smart control in preparation for session #3.

### Session #2 Result.

Table 2 shows the completion time (in seconds) for the human subjects (e.g., S1-S7) in Session #2.

TABLE 2

| Task | Control | S1 | S2 | S3 | S4 | S5 | S6 | S7 |
|---|---|---|---|---|---|---|---|---|
| #1 | Joystick | 69 | 69 | 65 | 65 | 77 | 73 | 70 |
| | Fabricated | 88 | 82 | 80 | 78 | 100 | 90 | 83 |
| | system | | | | | | | |
| #2 | Fabricated | 1.1 | 1.2 | 1.2 | 1.1 | 0.8 | 1.5 | 1.0 |
| | system | | | | | | | |
| #3 | Joystick | 45 | 45 | 45 | 43 | 49 | 45 | 47 |
| | Fabricated | 50 | 50 | 53 | 58 | 63 | 47 | 46 |
| | system | | | | | | | |
| #4 | Joystick | 46 | 42 | 43 | 48 | 56 | 45 | 4 |
| | Fabricated | 62 | 52 | 77 | 128 | 169 | 70 | 53 |
| | system | | | | | | | |
| #5 | Joystick | 32 | 25 | 40 | 30 | 48 | 31 | 22 |
| | Fabricated | 71 | 43 | 66 | 70 | 63 | 44 | 31 |
| | system | | | | | | | |

Table 2 shows that for task #1, the average completion time across all subjects was 23% slower than with the joystick. The study found that driving backward with the fabricated system was the main contributor to this reduced performance, possibly due to the PWC not remaining in a straight line when switching driving between forward and backward. Subjects found it easier to correct this deviation with joysticks because they could push it in diagonal positions. It was more difficult to drive diagonally with the head, therefore subjects had to issue coarser and slower corrections with the fabricated system that also included stopping the PWC at times. In practice, this difference in completion time between the joystick and the fabricated system may be less significant because end-users may roll forward most of the time, and even when they roll backward, it may not be for a long distance that requires making such corrections.

For task #2, all subjects can stop the PWC with a facial gesture in around 1 second, which indicates that the fabricated system was responsive and can be used in case of emergency. However, more testing may need to be done on various road surfaces (e.g., bumps, gravels, unpaved roads, etc.) to validate its reliability better.

For task #3, subjects completed the U-turn maneuver in an average of 46 sec with the joystick and 52 sec (13% slower) with the fabricated system. Although not shown in Table 2, the completion time remained consistent across the three trials of the fabricated system for each subject, indicating that the subjects were confident in turning using the fabricated system's head tracking, and the control was intuitive. Moreover, no subjects collided with the cone, indicating that subjects could accurately drive the PWC around an object if ample space was provided.

For task #4, the average completion time with the fabricated system was 85% slower than with the joystick. Because of the task's difficulty, differences in performance with the fabricated system were found between subjects, such as subject #5 completing the task 3× slower than the fastest subject. Prior experience with PWC driving might affect performance since the fastest subjects (Subjects 2 and 7) were experienced PWC drivers. Although this task was designed to be challenging, all subjects zigzagged through the cones without any collision, except for Subjects 1 (1 collision) and Subject 4 (3 collisions). Regardless, these four collisions accounted for less than 3% of the total number of collisions that could have occurred, and only one was a head-on collision against a cone.

For task #5, the average completion time with the fabricated system was 66% slower than with the joystick. There were also differences in performance with the fabricated system, with Subject 7 completing this task on average 2.3× faster than the slowest subject. Besides Subject 4, all other subjects can clear a mock doorway unimpeded in at least one trial, which confirmed that they can drive the PWC inside the house for Session #3. Subject 4 had technical issues limiting her ability to drive with fine control. The head sensor was placed too close to the neck, which degraded proper head tracking, and the calibration lacked parameter adjustments that could have reduced the impact of this issue, among other problems. The study learned from it and made changes to the fabricated system's software and to the sensor attachment procedure that resulted in improved satisfaction by all subjects, including Subject 4, as shown by an increase in their scoring of difficulty level in Session #3.

### Session #3 Result.

Table 3 shows the completion time (in seconds) for the human subjects (e.g., S1-S7) in Session #3.

TABLE 3

| Task | Control | S1 | S2 | S3 | S4 | S5 | S6 | S7 |
|---|---|---|---|---|---|---|---|---|
| #1 | Joystick | 18 | 17 | 23 | 19 | 21 | 16 | 16 |
| | Fabricated | 33 | 27 | 28 | 27 | 36 | 23 | 18 |
| | system | | | | | | | |
| #2 | Joystick | 37 | 24 | 31 | 26 | 32 | 27 | 27 |
| | Fabricated | 89 | 58 | 101 | 66 | 75 | 50 | 61 |
| | system | | | | | | | |
| #3 | Joystick | 49 | 43 | 45 | 40 | 62 | 48 | 44 |
| | Fabricated | 128 | 93 | 154 | 106 | 138 | 97 | 85 |
| | system | | | | | | | |
| #4 | Joystick | 59 | 59 | 59 | 55 | 56 | 58 | 53 |
| | Fabricated | 107 | 92 | 129 | 104 | 102 | 98 | 89 |
| | system | | | | | | | |

In task #1, Table 3 shows the average completion time across all subjects was 42% longer with the fabricated system than the joystick. Subjects 6-7 were the fastest with prior experience with the fabricated system, and the average completion time of Subject 7 was only 17% longer than with the joystick. All subjects could clear the doorway unimpeded in their third trial, and only one head-on collision was reported for Subject 4 in her second trial. Three other collisions were recorded across all subjects and trials, but they were merely a brushing of either the opened door or the side of the doorway.

In task #2, the completion time with the fabricated system was, on average, 2.5× slower than a joystick. However, the main contributor to this difference in performance was that subjects could look at the TV while using their hand/fingers to use the Roku app on the phone, but with the fabricated system, they had to look back and forth between the screens of the phone and the TV. Only one collision occurred for Subject 4 in her first trial with the fabricated system, who slightly bumped into the table, but the subject learned from it and completed all other trials without collision.

Similar observations were seen in task #3, for which the total completion time for the fabricated system was 2.4× longer than with the joystick/hand. It was more efficient to use hand/fingers to use a smartphone with a touchscreen and a computer mouse to move a pointer and click. However, the subjects switched between three devices independently (PWC, then a smartphone, followed by a computer) and performed human-computer interactions (e.g., scrolling, navigating a website, playing a video) in less than 3 min for the slowest subject (154 sec). No collisions were reported with the fabricated system, indicating that all subjects became proficient with indoor driving.

Task #4 was completed on average 1.8× slower with the fabricated system. Opening the automated door with the smartphone was the main contributor to the delay because it was 5× slower. However, this duration included switching control between PWC to the phone and back to PWC. There was a difference in performance between subjects that was not observed with the joystick/hand. The fastest subject (S7) completed the task with the fabricated system on average 1.5× faster than the slowest (S3), indicating that increased practice time with the fabricated system may lead to improved performance in driving and smart control. More collisions were reported in this task because it was challenging in terms of fine driving due to the doorway not being American-with-Disabilities-Act (ADA) compliant. However, all subjects had at least one trial with the fabricated system in which they cleared the doorway unimpeded, and even two subjects (S1 and S7) completed all trials without any collision. Additionally, only Subject 3 had one head-on collision with the side of the door, for which he corrected the trajectory of the PWC and cleared the doorway unimpeded. The other 10 collisions were merely a brush of the opened door or the sides of the doorway, which did not require the subject to correct trajectory.

### Subject Feedback.

For smart control, all subjects were satisfied with the fabricated system's performance. A main concern was the issue of overshooting small targets on the smartphone, but all acknowledged that they may perform better with more practice and without the pressure of being timed. Nonetheless, new users may be encouraged to start with a low pointer speed to increase accuracy and reduce the frustration of overshooting targets. Once the user becomes proficient enough with head control, the pointer speed can increase.

For PWC driving, besides the issue with Subject 4 in Session 2 that was resolved in Session #3, all subjects reported that they felt in control of the PWC and were satisfied. A challenge was with fine driving control that was made harder due to the casters on the PWC that proved difficult to maintain straight driving. This made clearing a doorway more difficult than it may be in real life because, in the study, the doorways and thresholds were not ADA-compliant, thus reducing the margin of error to such an extent that a small misalignment due to the casters resulted in brushing or colliding with the door frame. Nonetheless, there was only one head-on collision with the door frame that was reported in the house (Session #3); all others were merely brushing the open door or the door frame.

### Testing.

The embodiment in FIG. 7A was developed and tested in technical testing completed by seven able-bodied individuals over three sessions (Sebkhi et al., 2023). Participants were trained on using the fabricated system to control connected devices in the first session and then on driving a power wheelchair in the second session. In the third session, both controls were combined to perform tasks of daily living inside a house, such as watching a movie on a smart TV, using a computer to navigate on the Internet, and actuating an automated door opener to access the bedroom. Although all participants completed the tasks, some participants had to perform the same body gesture many times before being detected by the system. Therefore, Improvement #1 was focused on the reliability of the body gesture detection algorithm (i.e., a trained ML model) to reduce user frustration and abandonment.

In the embodiment in FIG. 7A, all output communications were implemented in the interface, including Bluetooth connection to digital devices. This required the interface to always be in the vicinity of the user, even when moved away from the wheelchair. Because the interface was also wired to the wheelchair's specialty control input module (SCIM), the interface may not be moved with the user. Therefore, Improvement #2 was focused on the wearability of the fabricated system by transferring all data processing, including body gesture detection and all wireless output communications, into the controller. Then, a wireless SCIM receiver may be developed to receive wireless outputs from the controller, translating them into wheelchair controls and transmitting them to the wheelchair's SCIM.

The study recruited an internal user tester throughout development activities. During planning, the user tester periodically reviewed the user requirements to ensure the engineering prototype responded to actual user needs. The user tester iteratively tested the improved designs and provided suggestions to increase compliance with user requirements. This iterative and user-centric development facilitated the successful completion of functional testing (Improvement #3) to evaluate whether the prototype was functional and reliable.

### Body Gesture Detection.

A previous study developed a prototype of a body motion tracking system, but significant development was still undertaken in the instant study to demonstrate the reliability of the gesture detection algorithm. The previous study collected limited datasets of body gestures (head and face) in a technical testing with seven abled-bodied individuals (Sebkhi, et al., 2023) and six SCI patients at Shepherd Center. Four tracers were used in this testing: one tracer behind the ear to track head motion for proportional control, one tracer in each cheek, and one tracer above an eyebrow. Therefore, the instant study used the gesture datasets collected from these 13 participants to improve the body gesture detection algorithm. Table 4 lists the gesture datasets with the instructions provided to the participants, along with the specific objectives and desired outcome of the detection algorithm improvement that was performed to demonstrate the highest level of reliability.

TABLE 4

| Dataset | Instruction | Objective | Outcome |
|---|---|---|---|
| Motion artifact from | Without activating any | Evaluate how reliably the | Gestures should |
| head movement | tracer, move the head in | algorithm can isolate body | not be detected. |
| | all directions and finish | movements that were not | |
| | by shaking it erratically | user-intended gestures. | |
| | for about 5 seconds. | | |
| Motion artifact from | Read the passage out | Evaluate how well the | Gestures should |
| speaking | loud. | algorithm can differentiate | not be detected. |
| | | between a facial tracer | |
| | | moving due to speech and | |
| | | the user intending to | |
| | | generate a command. Facial | |
| | | gestures were the only | |
| | | remaining gestures available | |
| | | to some users with complete | |
| | | tetraplegia. | |
| | | Grandfather passage was | |
| | | used because it included all | |
| | | phonemes found in the | |
| | | English language (Boutsen | |
| | | et al., 2022). | |
| Gestures in static | While keeping the head | Evaluate the accuracy of | Five gestures |
| condition | still, complete five | detecting gestures in a | should be detected |
| | gestures for each | simple static condition | for each tracer. |
| | tracer. | where the motion of a tracer | |
| | | was only induced by a body | |
| | | gesture, thus removing any | |
| | | interference from other body | |
| | | motion artifacts. | |
| Gestures in dynamic | Move the head in all | Evaluate the accuracy of | Five gestures |
| condition | directions, and complete | detecting gestures when | should be detected |
| | five gestures for each | body motion artifacts are | for each tracer. |
| | tracer. | present. For the facial | |
| | | tracers, head movement is | |
| | | the body motion artifact that | |
| | | should not be detected | |
| | | as a user-intended gesture. | |

The study further collected larger datasets of motion of additional body parts (e.g., shoulder, elbow, knee) and across many individuals to account for inter-subject variability. Additionally, the body gesture detection algorithm filtered out unintended but natural body movements, and external motion artifacts due to the power wheelchair driving on a wide range of terrain. These datasets were used to develop a more advanced data processing pipeline that used the latest advances in machine learning and inertial-based localization to overcome the technical challenges caused by the complexity of movements from different body parts and learning gesture patterns unique to each user.

### Wearability.

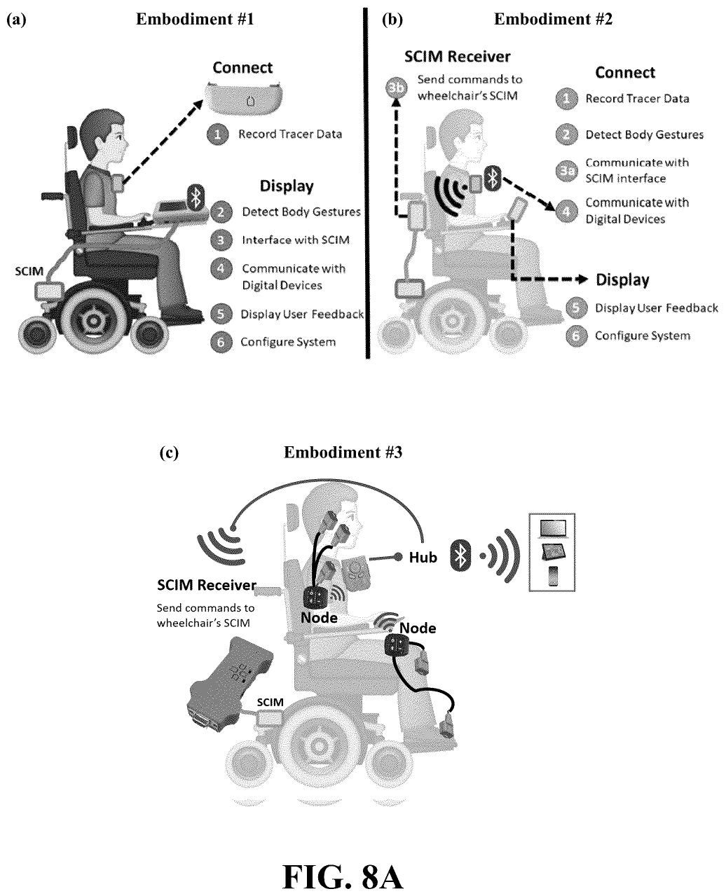

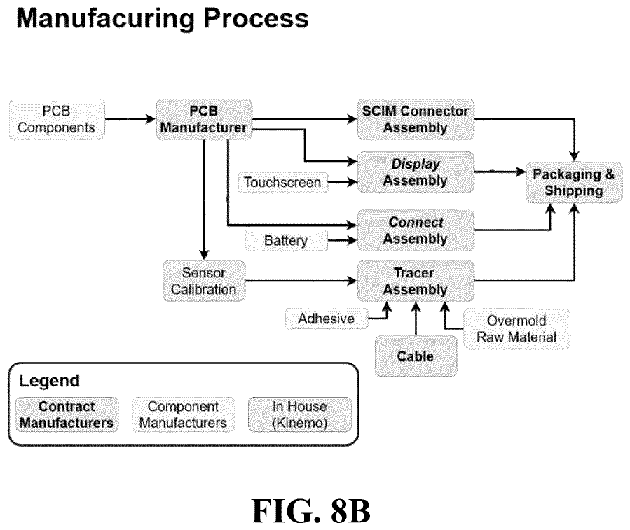

FIG. 8A shows the three embodiments of the exemplary system: embodiment #1, embodiment #2, and embodiment #3.

In the embodiment in subpanel (a) (and used in experiments), all data processing and communication functionalities were implemented in the interface, except for recording motion data from the tracers. This heavy reliance on the interface was chosen to facilitate early hardware development by limiting the number of electronic boards to be designed, manufactured, and assembled, and simplifying software development. However, this design approach was not optimal for an engineering prototype. First, the interface with dimensions of 15×10×3 cm³ was cumbersome and added clutter to the wheelchair, according to user feedback. What occupied the most space was the hardware to connect to the wheelchair's SCIM, which required a large 9-pin connector and a 3.5 mm jack port to enable proportional wheelchair control and mode-switching capabilities. Therefore, the SCIM portion was moved into its standalone receiver device to reduce the size of the interface as shown in subpanel (b).

Secondly, in the embodiment #1, the interface needed to be in the vicinity of the user when controlling a digital device since all data processing and Bluetooth communication was done on the interface. Even though the power wheelchair with the interface was close to the user most of the time the study, as shown in subpanel (b), decoupled these two functions from the interface and implemented them into the controller in order to make digital control independent from the wheelchair. This allowed users to continue using the fabricated system to access their digital devices without relying on the location of their wheelchair, which was useful when users were transferred to their bed, for instance. To add this feature, the study, as shown in subpanel (b), upgraded the controller's firmware to run all data processing, including the body gesture detection algorithm, along with implementing wireless Bluetooth connectivity to enable the controller to communicate with digital devices and the interface, and a proprietary RF protocol with the SCIM receiver to guarantee communication stability and low latency.

The outcome of this task was a file containing all the schematics, enclosure designs, and bills of material needed by a contract manufacturer to manufacture and assemble the engineering prototype.

### Functional Testing.

To demonstrate that the engineering prototype was functional and reliable, an internal user tester and his caregiver completed a set of tasks. Table 5 shows the set of tasks completed by the user tester and his caregiver.

TABLE 5

| Task | Outcome |
|---|---|
| 1. The caregiver prepared | The disposable sticker can snap in the sensor |
| and adhered the sensors | without applying excessive force; the |
| (i.e., tracers) to body | release liner was easy to remove; the caregiver |
| parts of the user. | understood the proper locations for the sensors. |
| 2. The caregiver operated | The caregiver understood how to navigate the |
| the interface to calibrate | user interface to start tracer calibration; the |
| the sensors. | caregiver provided accurate instructions to the |
| | user to calibrate each tracer; the caregiver |
| | understood when a calibration succeeded or |
| | failed; the caregiver knew the reasons for a |
| | failed calibration and how to fix them. |
| 3. The caregiver operated | The caregiver understood how to navigate the |
| the interface to configure | user interface to configure input/output |
| output controls. | controls for each target device type. |
| 4. The user completed | The reliability of gesture detection was |
| the accuracy test of | demonstrated for this user if greater than 90% |
| body gesture detection. | of gestures were detected. |
| 5. The caregiver tested | The detection of unusual sensor motion and |
| the automated emergency | triggering an emergency stop was validated. |
| stop by detaching a | |
| sensor and letting it fall. | |
| 6. The user issued an | The user demonstrated the ability to issue a |
| emergency stop using the | combination of user-defined gestures to activate |
| fabricated system only. | the emergency stop. |
| 7. The user completed a | The user completed all the tasks outlined in the |
| set of digital control | technical testing (Sebkhi, et al., 2023) |
| and power wheelchair | in a reasonable amount of time to demonstrate |
| driving tasks. | proficiency with the fabricated system. |
| 8. The user used the | The sensors remained adhered to the skin for a |
| fabricated system as the | full day of use (at least 12 hours); the |
| main controller for a | accuracy of body gesture detection remained |
| full day. | satisfactory; there were no visible or reported |
| | signs of skin irritation. |

### Fabricating the Embodiment #2

FIG. 8B shows the fabrication process of the embodiment #2. As shown, the fabrication process required a combination of component manufacturers that provided raw materials and components, contract manufacturers that produced and assembled parts of the system, and an in-house sensor calibration procedure.

### Discussion

### Discussion #1.

After being diagnosed with tetraplegia due to spinal cord injury (SCI) or neurodegenerative disease (e.g., MS, ALS), these individuals not only deal with life-changing consequences to their mobility and independence but also endure a high rate of unemployment of more than 70% (National Spinal Cord Injury Statistical Center, 2023) while most of them (79%) reported that they want to work (Ottomanelli, & Lind, 2009). This high rate of unemployment is in contrast with the high financial burden as a result of their tetraplegia, which is estimated at millions of dollars of lifetime costs (National Spinal Cord Injury Statistical Center, 2023), and results in 25% filing for bankruptcy five years post-injury (Merritt, et al., 2019). Additionally, nearly half of this population show signs of mental health problems, including depression, anxiety, and post-traumatic stress disorder (Migliorini et al., 2008).

An obstacle for people with tetraplegia to regain access to employment is a lack of autonomy due to reliance on their caregivers for daily activities, limited mobility, and lack of access to digital devices, wherein the digital devices are developed to be controlled by hands and fingers (e.g., keyboard, mouse, touchscreen). Therefore, when upper control is impacted, these individuals rely on alternative control for their needs of mobility and access to their digital devices. However, alternative control solutions in the market pose problems that hinder these individuals' abilities to regain autonomy.

Current state-of-the-art controllers (Watanabe, 2017) are rudimentary and present many challenges (Evans, et al., 2007). For instance, the head array and sip-and-puff are common controllers for driving a power wheelchair, often called alternative drive systems. The head array (Stealth Products, 2019) provides a few switches that are activated by a head press, which can only deliver simple controls and is tiresome for the neck, and the sip-and-puff acts as a simple switch by puffing or sipping through a straw (Mougharbel et al., 2013). Although new versions of these switch-based alternative drive systems can offer some form of proportional control, they are difficult to operate when attempting to output precise controls to drive their wheelchair. If a user has proportional control, chin joysticks are often needed instead (Dicianno, et al., 2010), but they are cumbersome, tiresome, and painful for the neck over time (Dolan, & Henderson, 2017). Similarly, specialized joysticks offer proportional control but are limited to users with a sufficient range of motion in their upper body extremities, excluding people with complete tetraplegia.

An issue with these alternative drive systems is that they are permanently mounted to the power wheelchair. Apart from adding more clutter to the wheelchair, any shift in the user's position can put them out of reach, which can result in a dangerous situation while driving the wheelchair. If this occurs, the user can no longer operate the controller(s) thus burdening their caregiver to supervise and reposition the user. Also, users may have mobility in areas that cannot be easily captured by wheelchair-mounted controllers, such as limited head, shoulder, finger, or even knee motion, thus losing out on opportunities to improve their control options.

Besides power wheelchair control, being connected to a smartphone, tablet, or computer is essential. Users with an up-to-date wheelchair can use their wheelchair's built-in Bluetooth to convert the output controls of their alternative drive system into digital controls, while others have to purchase external adapters out of pocket. Regardless, the controllers developed for driving do not provide the complex level of human-computer interaction required to control digital devices.

Additionally, these controllers cannot be used if the user is transferred out of the wheelchair because they are permanently mounted to the wheelchair. Instead, users have to purchase a separate alternative controller dedicated to digital device control, such as a head tracker. These controllers are set up by the users' caregivers each time the users want to control a digital device, and most can only control one device at a time. This requires extended intervention by the caregiver to switch between many devices or multiple alternative controllers must be bought to control each digital device. These alternative controllers can cost thousands of dollars out of pocket since they are not reimbursed by insurance. Finally, voice commands are used by some users but as a secondary input method to an alternative controller because of a slow information rate, lack of privacy, and inefficiency in a noisy environment (Chauhan, et al., 2016; Skraba, et al., 2014).

### Discussion #2.

Current state-of-the-art alternative controllers in the market do not provide the level of independence required by individuals living with tetraplegia, contributing to their challenges in accessing employment and participating in social activities (Migliorini et al., 2008; Ottomanelli & Lind, 2009). Users want to control both their power wheelchair and digital devices with one reimbursable device while using advanced input controls to increase effectiveness and be decoupled from the wheelchair to increase independence.

To increase the effectiveness of power wheelchair driving, proportional controls from any part of the body that still has sufficient motion (e.g., head, arm, wrist, knee) should be harnessed and customized to the user's specific range of motion. To access a digital device, both discrete and proportional controls are needed to move a pointer (proportional) and click on objects (discrete) for a computer or emulate a finger tap (discrete) and finger swipe (proportional) for a touchscreen. State-of-the-art alternative controllers cannot provide both discrete and proportional controls or cannot integrate power wheelchair driving and digital device control together. Most power wheelchair users would prefer a wearable controller (Carrington, et al., 2014) to maintain digital control when moved away from the wheelchair.

Therefore, users need a wearable alternative controller that combines proportional and discrete controls to enable advanced human-computer interaction and driving capabilities while providing control of both their wheelchairs and digital devices and allowing them to switch between all controlled devices seamlessly and independently of their caregivers.

### Discussion #3.

Previous studies developed advanced alternative controllers based on new sensing technologies and signal processing. For instance, voluntary facial muscle movements can be captured by electromyograms (EMG) (Scheme, et al., 2011; Scheme, & Englehart, 2011), eye movements by electrooculogram (EOG) (Barea Navarro, et al., 2018; Champaty, et al., 2014; Ianez, et al., 2013), or a combination of both (Lopez, et al., 2015). However, the issue with EOG and EMG is that the recording can be limited for some individuals (Paralyzed Veterans of America Consortium for Spinal Cord, 2005; Ropper et al., 2015), which reduces the effectiveness of head tracking alone. Therefore, most head trackers can be connected to specialized switches to issue discrete controls. However, these additional switches add clutter around the head that may prevent users from performing some daily activities (e.g., eating, drinking) and being a burden for all-day use since they require recalibration every time the controller is put back on the user.

The exemplary system was developed for people with tetraplegia to use any remaining body motion to generate both proportional and discrete controls. With this combination of proportional and discrete inputs, the exemplary system may replace the need for multiple expensive controllers and allow users to drive their power wheelchairs, efficiently access their digital devices, and switch control between devices without caregiver intervention or hardware adjustment. Additionally, the exemplary system may be fully covered by insurance, saving users thousands of dollars from buying additional controllers.

### Discussion #4.

The combination of fully integrated multimodal inputs, either sequentially or simultaneously, offers new control capabilities that this population cannot access. For instance, the controller of the exemplary system may issue both discrete and proportional controls simultaneously, allowing the user to drive the wheelchair with proportional head control while using body gestures to activate discrete commands to stop the chair, adjust seating, and set the speed, among others. When controlling digital devices, actions such as drag-and-dropping on a computer or swiping on a smartphone require simultaneous switch and proportional control.

The wearable form factor of the exemplary system may allow users to have control of their digital devices from anywhere, reducing the burden on their caregivers to set up a new controller every time the user is moved in and out of the wheelchair. Additionally, since the exemplary system may not rely on headgear for head control, the exemplary system may not be prone to interruptions of use due to headgear shifting or falling off, and the user's seating has no effect on the system's functionality.

By adapting control to the user's range of motion and tracking places on the body that no existing controllers can, the exemplary system may offer a unique customization level that can evolve with the progression of a user's paralysis. This adaptability may enable the exemplary system to benefit a larger population than only those with complete tetraplegia, and the exemplary system can remain useful throughout the progression of the user's condition without the need to purchase additional equipment or change to a different alternative controller altogether. This is helpful for users living with amyotrophic lateral sclerosis, multiple sclerosis, muscular dystrophy (Dolan & Henderson, 2017), Parkinson's disease, among other neurodegenerative diseases.

Any assistive technology for a disability should be as inconspicuous as possible to attract less attention and thus improve social acceptance (Shinohara & Wobbrock, 2011). Naturally, there is a trade-off between capturing input modalities from the user's body parts and designing an inconspicuous technology with hidden hardware. This issue is challenging for some users with complete tetraplegia because visible hardware on the head draws the most attention among all visible body parts, especially when the head is the only body part available for alternative control for that population. Therefore, the study developed the exemplary system for social acceptance by decreasing the size for all visible components (e.g., wire and sensor enclosure).

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] Anderson, J. (2022). Assistive Technology Update In MagTrack with Nordine Sebk-hi and Arpan Bhaysar. https://www.eastersealstech.com/2022/04/15/atu568-magtrack-with-nordinesebkhi-and-arpan-bhaysar/
[2] Barea Navarro, R., Boquete Vazquez, L., & Lopez Guillen, E. (2018). EOG-based wheelchair control. In Smart Wheelchairs and Brain-Computer Interfaces (pp. 381-403). Academic Press.
[3] Boutsen, F., Park, E., & Dvorak, J. D. (2022). Reading Warm-Up, Reading Skill, and Reading Prosody When Reading the My Grandfather Passage: An Exploratory Study Born Out of the Motor Planning Theory of Prosody and Reading Prosody Research. Journal of Speech, Language, and Hearing Research, 65(6), 2047-2063.
[4] Bulling, A., & Gellersen, H. (2010). Toward Mobile Eye-Based Human-Computer Interaction. Ieee Pervasive Computing, 9(4), 8-12.
[5] Carrington, P., Hurst, A., & Kane, S. K. (2014). Wearables and chairables: Inclusive design of mobile input and output techniques for power wheelchair users Proc. of the SIGCHI Conf. on Human Factors in Computing Systems,
[6] Champaty, B., Jose, J., Pal, K., & Thirugnanam, A. (2014). Development of EOG Based Human Machine Interface control System for Motorized Wheelchair. International Con” on Emerging Research Areas: Magnetics, Machines and Drives.
[7] Chauhan, R., Jain, Y., Agarwal, H., & Patil, A. (2016). Study of Implementation of Voice Controlled Wheelchair. International Conf. on Advanced Computing and Communication Systems.
[8] Cowart, D., Morris, J., Sebkhi, N., Bhaysar, A., & man, 0. (2023). Usability study of Kinemo, a wearable alternative controller using on-body gesture recognition for digital control by people with tetraplegia. Assistive Technology, (in-review).
[9] DeRuyter, F., Jones, M., & Morris, J. (2020). Mobile Health and Mobile Rehabilitation for People with Disabilities: Current State, Challenges and Opportunities: Introduction to the Special Thematic Session. International Conference on Computers Helping People with Special Needs,
[10] Dicianno, B. E., Cooper, R. A., & Coltellaro, J. (2010). Joystick control for powered mobility: current state of technology and future directions. Phys Med Rehabil Clin N Am, 21(1), 79-86.
[11] Dolan, M. J., & Henderson, G. I. (2017). Control devices for electrically powered wheelchairs: prevalence, defining characteristics and user perspectives. Disability & Rehabilitation: Assistive Technology, 12(6), 618-624.
[12] Evans, S., Neophytou, C., de Souza, L., & Frank, A. 0. (2007). Young people's experiences using electric powered indoor −outdoor wheelchairs (EPIOCs): potential for enhancing users' development? Disabil Rehabil, 29(16), 1281-1294.
[13] Fernandez-Rodriguez, A., Velasco-Alvarez, F., & Ron-Angevin, R. (2016). Review of real braincontrolled wheelchairs. J Neural Eng, /3(6), 061001.
[14] Fox 5 Atlanta. (2022). Georgia Tech researchers develop way for wheelchair users to steer with head tilts, facial expressions. https://www.fox5atlanta.cominews/georgia-techresearchers-develop-way-for −wheelchair-users-to-steer-with-head-tilts-facial-expressions
[15] Georgia Research Alliance. (2023). Technology from startup Kinemo empowers people with limited mobility. https://gra.org/stories/1062/
[16] Georgia Tech. (2022). Providing More Accessibility to People Living With Paralysis. 2022 President's Report. https://report2022.president.gatech.edu/research #Providing-More-Accessibility-to-People-Living-With-Paralysis
[17] Hansen, J. P., K. limning, A. S. Johansen, K. Itoh, & Aoki, H. (2004). Gaze typing compared with input by head and hand Proceedings of the 2004 symposium on Eye tracking research & applications.
[18] Ianez, E., Azorin, J. M., & Perez-Vidal, C. (2013). Using Eye Movement to Control a Computer: A Design for a Lightweight Electro-Oculogram Electrode Array and Computer Interface. PLOS One, 8(7).
[19] Jones, M., DeRuyter, F., & Morris, J. (2020). The digital health revolution and people with disabilities: perspective from the United States. International journal of environmental research and public health, /7(2), 381.
[20] Krolak, A., & Strumillo, P. (2012). Eye-blink detection system for human-computer interaction. Universal Access in the Information Society, 11(4), 409-419.
[21] Learmonth, Y. C., Rice, I. M., Ostler, T., Rice, L. A., & Motl, R. W. (2015). Perspectives on physical activity among people with multiple sclerosis who are wheelchair users: informing the design of future interventions. International journal of MS care, /7(3), 109-119.
[22] Long, J. Y., Li, Y. Q., Wang, H. T., Yu, T. Y., Pan, J. H., & Li, F. (2012). A Hybrid Brain Computer Interface to Control the Direction and Speed of a Simulated or Real Wheelchair. IEEE Trans. on Neural Systems and Rehabilitation Engineering, 20(5), 720-729.
[23] Lopes, A. C., Pires, G., & Nunes, U. (2013). Assisted navigation for a brain-actuated intelligent wheelchair. Robotics and Autonomous Systems, 61(3), 245-258.
[24] Lopez, N. M., Orosco, E., Perez, E., Bajinay, S., Zanetti, R., & Valentinuzzi, M. E. (2015). Hybrid Human-Machine Interface to Mouse Control for Severely Disabled People. International Journal of Engineering and Innovative Technology, 4(11), 164-171.
[25] Martin, B. (222 Jun. 2022). MagTrack Control. Paraplegia News Magazine, 16-18.
[26] Mehta, P., Raymond, J., Punjani, R., Larson, T., Bove, F., Kaye, W., Nelson, L. M., Topol, B., Han, M., & Muravov, 0. (2022). Prevalence of amyotrophic lateral sclerosis (ALS), United States, 2016. Amyotrophic Lateral Sclerosis and Frontotemporal Degeneration, 23(3-4), 220-225.
[27] Merritt, C. H., Taylor, M. A., Yelton, C. J., & Ray, S. K. (2019). Economic impact of traumatic spinal cord injuries in the United States. Neuroimmunology and neuroinflammation, 6.
[28] Migliorini, C., Tonge, B., & Taleporos, G. (2008). Spinal cord injury and mental health. Australian & New Zealand Journal of Psychiatry, 42(4), 309-314.
[29] Morris, J. T., Thompson, N. A., & Center, S. (2020). User personas: smart speakers, home automation and people with disabilities. J. Technol. Persons Disabil, 8.
[30] Mougharbel, I., El-Hajj, R., Ghamlouch, H., & Monacelli, E. (2013). Comparative study on (Afferent adaptation approaches concerning a sip and puff controller for a powered wheelchair IEEE Science and Information Conference.
[31] National Spinal Cord Injury Statistical Center. (2023). Traumatic Spinal Cord Injury Facts and Figures at a Glance. University of Alabama at Birmingham. https://www.nscisc.uab.edu/public/Facts % 20and %20Figures %202023%20-%20Final.pdf
[32] Ottomanelli, L., & Lind, L. (2009). Review of critical factors related to employment after spinal cord injury: implications for research and vocational services. The journal of spinal cord medicine, 32(5), 503.
[33] Paralyzed Veterans of America Consortium for Spinal Cord, M. (2005). Preservation of upper limb function following spinal cord injury: a clinical practice guideline for health-care professionals. J Spinal Cord Med, 28(5), 434-470.
[34] Parmelee, G. (2022). Mag Track Technology Opens Doors for Independent Operation of Smartphones, Computers, and Other Devices for Wheelchair Users. Georgia Tech News Center. https://news.gatech.edu/news/2022/03/03/magtrack-technology-opens-doorsindependent-operation-smartphones-computers-and
[35] Ropper, A. E., Neal, M. T., & Theodore, N. (2015). Acute management of traumatic cervical spinal cord injury. Pract Neurol, 15(4), 266-272.
[36] Salari, N., Fatahi, B., Valipour, E., Kazeminia, M., Fatahian, R., Kiaei, A., Shohaimi, S., & Mohammadi, M. (2022). Global prevalence of Duchenne and Becker muscular dystrophy: a systematic review and meta-analysis. Journal of orthopaedic surgery and research, 17(1), 1-12.
[37] Scheme, E., Biron, K., & Englehart, K. (2011). Improving Myoelectric Pattern Recognition Positional Robustness Using Advanced Training Protocols. IEEE Engineering in Medicine and Biology Society, 4828-4831.
[38] Scheme, E., & Englehart, K. (2011). Electromyogram pattern recognition for control of powered upper-limb prostheses: State of the art and challenges for clinical use. Journal of Rehabilitation Research and Development, 48(6), 643-659.
[39] Sebkhi, N., Bhaysar, A., McCoy, M., & man, 0. T. (2023, Jul. 25, 2023). Technical validation of Kinemo, a wearable alternative controller for smart control and power wheelchair driving RESNA Conference, New Orleans, LA.
[40] Sebkhi, N., Bhaysar, A., Sahadat, M. N., Baldwin, J., Walling, E., Biniker, A., Hoefnagel, M., Tonuzi, G., Osborne, R., Anderson, D., & man, 0. T. (2022). Evaluation of a Head-Tongue Controller for Power Wheelchair Driving by People With Quadriplegia. IEEE Trans Biomed Eng, 69(4), 1302-1309.
[41] Sebkhi, N., Bhaysar, A., Sahadat, M. N., Baldwin, J., Walling, E., Biniker, A., Hoefnagel, M., Tonuzi, G., Osborne, R., Anderson, D. V., & man, 0. (2021). Evaluation of a Head-Tongue Controller for Power Wheelchair Driving By People With Quadriplegia. IEEE Trans Biomed Eng, PP.
[42] Shepherd Center. (2021). Community Health Needs Assessment. https://www.shepherd.org/files/file/sc-community-health-needs-assessment-2021.pdf
[43] Shinohara, K., & Wobbrock, J. 0. (2011). In the shadow of misperception: assistive technology use and social interactions Proceedings of the SIGCHI Conf. on Human Factors in Computing Systems,
[44] Skraba, A., Koloivari, A., Kofja6, D., & Stojanovi6, R. (2014). Prototype of Speech Controlled Cloud Based Wheelchair Platform for Disabled Persons IEEE Mediterranean Conference on Embedded Computing.
[45] Stealth Products. (2019). i-drive head arrays. https://stealthproducts.com/abouthdrive-headarrays
[46] Walton, C., King, R., Rechtman, L., Kaye, W., Leray, E., Marrie, R. A., Robertson, N., La Rocca, N., Uitdehaag, B., & van Der Mei, I. (2020). Rising prevalence of multiple sclerosis worldwide: Insights from the Atlas of MS. Multiple Sclerosis Journal, 26(14), 1816-1821.
[47] Watanabe, L. (2017). A hierarchy of driving controls, Where to Start & How to Proceed When Assessing Power Chair Options. Mobility Management. Retrieved June from https://mobilitymgmt.com/Articles/2017/10/01/Driving-Controls.aspx
[48] Myburg, M., Allan, E., Nalder, E., Schuurs, S., & Amsters, D. (2017). Environmental control systems—the experiences of people with spinal cord injury and the implications for prescribers. Disability and Rehabilitation: Assistive Technology, 12(2), 128-136.
[49] Dolan, M. J., & Henderson, G. I. (2017). Control devices for electrically powered wheelchairs: prevalence, defining characteristics and user perspectives. Disability & Rehabilitation: Assistive Technology, 12(6), 618-624.
[50] Monden, K. R., Sevigny, M., Ketchum, J. M., Charlifue, S., . . . . Morse, L. R. (2019). Associations Between Insurance Provider and Assistive Technology Use for Computer and Electronic Devices 1 Year After Tetraplegia: Findings From the Spinal Cord Injury Model Systems National Database. Archives of Physical Medicine and Rehabilitation, 100(12), 2260-2266.
[51] Hooper, B., Verdonck, M., Amsters, D., Myburg, M., & Allan, E. (2018). Smart-device environmental control systems: experiences of people with cervical spinal cord injuries. Disability and Rehabilitation: Assistive Technology, 13(8), 724-730.

What is claimed:

1. A system comprising:
at least one set of sensors, including a first set of sensors configured to attach to a body part of a person, wherein each sensor is configured to generate a sensor measurement while the person is making a proportional movement or discrete gesture;
a controller having:
a processor; and
a memory having instructions stored thereon, wherein execution of the instructions causes the processor to:
receive, via the processor, the sensor measurement;
determine, via a gesture detection algorithm, a classification value using the sensor measurement, wherein the classification value has a correspondence to a pre-defined gesture among a plurality of gestures;
generate, via the processor, a control value using the classification value; and
output, via a communication module, the control value, wherein the control value is subsequently employed for controls of at least one device.

2. The system of claim 1, wherein the classification value is associated with a proportional gesture defined by a combination of positions, orientations, and angles, and wherein the output control value is employed as a proportional control output to the at least one device

3. The system of claim 2, wherein the classification value is associated with a discrete gesture defined by a combination of positions, orientations, and angles, and wherein the output control value is employed as a discrete control output to the at least one device

4. The system of claim 2 further comprising a second set of sensors configured for the discrete gesture of the person, wherein the controller is configured to:
receive, via the processor, second sensor measurements of the second set of sensors;
determine, via the gesture detection algorithm, a second classification value using the second sensor measurements;
generate, via the processor, a discrete control value using the second classification value; and
output, via the communication module, the discrete control value, wherein the discrete control value is subsequently employed, in combination with the proportional control output, for controls of at least one device.

5. The system of claim 1, wherein the classification value is associated with a gesture defined by a combination of positions, orientations, and angles.

6. The system of claim 4, wherein the least one set of sensors includes a non-reusable sticker part to adhere to a skin.

7. The system of claim 4, wherein the second set of sensors is configured to attach to a body part of a person, wherein each sensor is configured to generate the sensor measurement while the person is making a proportional movement or discrete gesture

8. The system of claim 1, wherein the controller is configured to:
store a first configuration for the control value for the subsequent control of a first device of the at least one device;
store a second configuration for the control value for the subsequent control of a second device of the at least one device;
upon receipt of a user command to select the first configuration for the control of the first device, load the controller with the first configuration; and
upon receipt of a user command to select the second configuration for the control of the second device, load the controller with the second configuration.

9. The system of claim 1, wherein the controller is configured to:
store a first configuration for the control value for the subsequent control of the least one device in association with a first sensor placement location on the body;
store a second configuration for the control value for the subsequent control of the least one device in association with a second sensor placement location on the body;
upon receipt of a user command to select the first configuration, load the controller with the first configuration; and
upon receipt of a user command to select the second configuration, load the controller with the second configuration.

10. The system of claim 1, wherein the control value is selectable to a second actionable control output corresponding to a transmission or mobile device or a user-defined device.

11. The system of claim 1, wherein the controller is operatively coupled to the set of sensors via a wire.

12. The system of claim 1, wherein the controller is operatively coupled to the set of sensors via a wireless tether.

13. The system of claim 1, wherein the controller includes a body strap to be positioned around a body part for operative coupling to the set of sensors.

14. The system of claim 6, wherein each sensor in the first set of sensors includes a clamping component configured to hold and release the non-reusable sticker part.

15. The system of claim 6, wherein each sensor in the second set of sensors includes a clamping component configured to hold and release the non-reusable sticker part.

16. The system of claim 1, wherein the gesture detection algorithm is selectable to output the control value for proportional control or discrete control.

17. A method for a remote control system having at least one set of sensors, including a set of sensors configured to attach to a first body part of a person, wherein each sensor is configured to generate a sensor measurement while the person is making a proportional movement or discrete gesture, the method comprising:
receiving, via a processor, the sensor measurement;
determining, via a gesture detection algorithm, a classification value using the sensor measurement, wherein the classification value has a correspondence to a pre-defined gesture among a plurality of gestures;
generating, via the processor, a control value using the classification value; and
outputting, via a communication module (e.g., Bluetooth, USB), the control value, wherein the control value is subsequently employed for controls of at least one device.

18. The method of claim 17 further comprising:
storing a first configuration for the control value for the subsequent control of a first device of the at least one device;
storing a second configuration for the control value for the subsequent control of a second device of the at least one device;
upon receipt of a user command to select the first configuration for the control of the first device, loading the controller with the first configuration; and
upon receipt of a user command to select the second configuration for the control of the second device, loading the controller with the second configuration.

19. The method of claim 18 further comprising:
positioning the first set of sensors at a first body location;
storing a first configuration for the control value for the control of the at least one device in association with the first body location;
repositioning the first set of sensors at a second body location;
storing a second configuration for the control value for the control of the least one device in association with the second body location;
upon receipt of a user command to select the first configuration, loading the controller with the first configuration; and
upon receipt of a user command to select the second configuration, loading the controller with the second configuration.

20. A non-transitory computer-readable medium having instructions stored thereon, wherein execution of the instructions by a processor causes the processor to:
receive, via the processor, a sensor measurement;
determine, via a gesture detection algorithm, a classification value using the sensor measurement, wherein the classification value has a correspondence to a pre-defined gesture among a plurality of gestures;
generate, via the processor, a control value using the classification value; and
output, via a communication module (e.g., Bluetooth, USB), the control value, wherein the control value is subsequently employed for controls of at least one device.
